(19) United States
(12) Patent Application Publication
(10) Pub. No.: US 2012/0123834 A1
(43) Pub. Date: May 17, 2012

(54) STORED VALUE EXCHANGE METHOD AND APPARATUS

(76) Inventors: Chris Nicolaidis, Encinitas, CA (US); Mark Sandson, Del Mar, CA (US); Steven J. Davis, Encinitas, CA (US)

(21) Appl. No.: 12/945,864

(22) Filed: Nov. 14, 2010

(51) Int. Cl. G06Q 30/00

(52) U.S. Cl. 705/14.11

(57) ABSTRACT

An apparatus and method for exchanging one form of stored value for another form of value. In one embodiment, a method for exchanging stored value for an alternative form of value comprises receiving stored value account information relating to the stored value from a remote user device and sending a request to a first value provider to provide an offer to exchange the store value for the alternative form of value. The method further comprises receiving the offer, the offer comprising a first offer to exchange the stored value for an alternative form of value and a supplemental offer comprising a supplemental value. The method further comprises sending the first offer and the supplemental offer to the remote user device for acceptance.

### BACKGROUND

I. Field of Use

The present application relates to the field of consumer stored value methods and apparatus. More specifically, the present application relates to methods and apparatus for exchanging one form of stored value for an alternative form of value.

II. Description of the Related Art

Over the years, stored value cards, such as gift cards, have become popular with consumers. A typical stored value card is issued by a merchant in the shape of a credit card and contains magnetically encoded data. The data may be read by a magnetic card reader, which ascertains a value represented by the stored value card and a merchant associated with the stored value card.

Stored value cards typically come in one of two forms. “Closed” stored value cards can only be redeemed at merchants associated with the stored value card. “Open” stored value cards may be redeemed at a variety of merchant stores or websites.

Stored value cards are used to pay for products and/or services, typically by presenting the stored value card to a cashier or automated device, or by providing information found on the stored value card to a web-site that accepts stored value cards as payment. The merchant (or third party) determines the value of the stored value card and determines whether there is a sufficient balance on the stored value card to complete the purchase. If a sufficient balance exists, the transaction continues, and the monetary value encoded upon the stored value card is reduced by the purchase amount to reflect a new balance. Alternatively, the monetary value associated with the stored value card is reduced on a remote computer maintained by the stored value card vendor, merchant, or other party.

The fact that most stored value cards can be used only within a specific issuing chain of merchants can present problems to stored value card holders. A person may have received a stored value card that is usable at a particular merchant where the person does not desire to make a purchase. For example, a person may have received a stored value card that is redeemable at a home improvement store, but the person does not own a home and therefore has no interest in purchasing goods or services from the home improvement store. Or, the person may have received a stored value card that is only valid at a certain restaurant chain, but the person does not like the particular restaurant chain.

To address this problem, several websites, such as PlasticJungle.com, cardpool.com, SwapaGift.com, and others, offer a stored value card exchange service. Users of such sites can trade their stored value cards for other stored value cards redeemable at merchants from whom they would rather conduct business. Typically, a user accesses such a website, selects a merchant and a stored value card amount that the user would like to use, and enters information relating to the user's stored value card that he/she currently possesses. The value of the preferred stored value card is generally less than the value of the user's currently-possessed stored value card. Once the user selects a desired stored value card and value, the user mails the currently possessed stored value card to an address associated with the stored value card exchange website, and the desired stored value card is mailed to the user after the undesired stored value card is received by operators or owners of the stored value card exchange website.

One problem with the above-described scenario is that the value offered for the user's gift card is typically far less than the value of the gift card. For example, a gift card worth $50 might only fetch an offer of $30 of value from one of the aforementioned gift card exchange websites. This may discourage a user from trading in his or her stored value in a particular transaction and perhaps discourage the user from using such stored value exchange services in the future.

It would be desirable if users could receive more alternative value for their stored value.

### SUMMARY

The embodiments described herein relate to methods and apparatus for exchanging one form of stored value for another form(s) of value. In one embodiment, a method for exchanging stored value for an alternative form of value is described, comprising receiving stored value account information relating to the stored value from a remote user device and sending a request to a first value provider to provide an offer to exchange the store value for the alternative form of value. The method further comprises receiving the offer, the offer comprising a first offer to exchange the stored value for an alternative form of value and a supplemental offer comprising a supplemental value. The method further comprises sending the first offer and the supplemental offer to the remote user device for acceptance.

In another embodiment, an apparatus for exchanging stored value for an alternate form(s) of value is described, comprising a network communication interface for receiving stored value account information relating to the stored value from a remote user device, for sending a request to a first value provider to provide an offer to exchange the store value for the alternative form of value, for receiving the offer, the offer comprising a first offer to exchange the stored value for an alternative form of value and a supplemental offer comprising a supplemental value, and for sending the first offer and the supplemental offer to the remote user device for acceptance. The apparatus further comprises a processor for generating the request.

In yet another embodiment, an apparatus for exchanging stored value for an alternate form(s) of value is described, comprising means for receiving stored value account information relating to the stored value from a remote user device, for sending a request to a first value provider to provide an offer to exchange the store value for the alternative form of value, for receiving the offer, the offer comprising a first offer to exchange the stored value for an alternative form of value and a supplemental offer comprising a supplemental value, and for sending the first offer and the supplemental offer to the remote user device for acceptance. The apparatus further comprises means for generating the request.

### BRIEF DESCRIPTION OF THE DRAWINGS

The features, advantages, and objects of the present invention will become more apparent from the detailed description as set forth below, when taken in conjunction with the drawings in which like referenced characters identify correspondingly throughout, and wherein:

FIG. 1 illustrates an apparatus for exchanging stored value for another form(s) of value;

FIG. 2 illustrates a first embodiment for exchanging stored value for an alternative form(s) of value;

FIG. 3 illustrates a second embodiment for exchanging stored value for an alternate form(s) of value;

FIG. 4 illustrates a third embodiment for exchanging stored value for an alternate form(s) of value;

FIG. 5 illustrates a fourth embodiment for exchanging stored value for an alternate form(s) of value;

FIG. 6 illustrates a fifth embodiment for exchanging stored value for an alternate form(s) of value;

FIG. 7 illustrates a sixth embodiment for exchanging stored value for an alternate form(s) of value;

FIG. 8 is a functional block diagram illustrating the functional components of an apparatus used in exchange stored value;

FIG. 9 is a functional block diagram illustrating the functional components of a value provider as mentioned in FIG. 2;

FIG. 10 is a functional block diagram illustrating the functional components of a value provider as described in FIG. 3;

FIG. 11 is a functional block diagram illustrating the functional components of a value provider as described in FIG. 4;

FIG. 12 is a functional block diagram illustrating the functional components of a value provider as described in FIG. 5;

FIG. 13 is a functional block diagram illustrating the functional components of a value provider as described in FIG. 6;

FIG. 14 is a flow diagram illustrating an embodiment of a process, performed by an apparatus, for exchanging one form of stored value for an alternative form(s) of value;

FIG. 15 is a flow diagram illustrating another embodiment of a process, performed by an apparatus, for exchanging one form of stored value for an alternative form(s) of value;

FIG. 16 is a flow diagram illustrating yet another embodiment of a process, performed by an apparatus, for exchanging one form of stored value for an alternative form(s) of value;

FIG. 17 is a flow diagram illustrating yet still embodiment of a process, performed by an apparatus, for exchanging one form of stored value for an alternative form(s) of value;

FIG. 18 is a flow diagram illustrating still another embodiment of a process, performed by an apparatus, for exchanging one form of stored value for an alternative form(s) of value; and

FIG. 19 is a flow diagram illustrating still yet another embodiment of a process, performed by an apparatus, for exchanging one form of stored value for an alternative form(s) of value.

### DETAILED DESCRIPTION

The present description relates to methods and apparatus for exchanging one form of stored value for another form of value. The term “value”, as used herein, comprises anything of monetary worth, such as money, credit, time (e.g., long-distance, payphone, or cell phone minutes), access to events, access to travel services, merchandise, social network credits (i.e., MySpace, FaceBook), gasoline, online credit (such as credit redeemable at Amazon.com), merchant credit (i.e., credit redeemable at a restaurant) , and the like. The term “stored value” comprises any value that is, or can be, stored or represented in or on a physical object or device. Examples of a physical object or device comprise stored value cards, such as gift cards, credit cards, pre-paid phone cards, payroll cards, debit cards, wireless communication devices such as mobile telephones, smart phones, mobile computing devices, such as an iPad or the like, fixed computing devices, servers, smart phones, key fobs, vouchers, or any instrument useable in commerce in place of money, or any instrument that entitles the bearer to acquire, utilize, or exhaust any commercially available product or service. “Stored value account information” comprises an account identification, such as an account number, an account value or balance, an amount of the account value or balance willing to be exchanged for another form of value, a merchant or financial institution associated with the account value or balance, merchant information pertaining to where the stored value may be redeemed, an identification of an account owner, and/or other information. Stored value account information may further comprise an identification of a preferred merchant whom a user desires to transact future business. Stored value account information could further comprise information relating to an “exchange option”, i.e., a selection by a user, at the commencement of an exchange, indicating a value type and a value amount preferred by the user. Further, as used throughout this description, the term “card” shall be understood to include both prepaid and non-prepaid cards, unless the particular context requires otherwise. The term “value provider” shall be understood to mean any entity willing to exchange goods or services, in any form, for a user's stored value. Examples of such value providers comprise debit card companies, stored value exchange web sites, such as www.PlasticJungle.com, banks and other financial institutions, merchants such as retail stores, restaurants, movie theaters, grocery stores, etc., social networking websites such as MySpace and FaceBook, pre-paid phone card companies, pre-paid fuel companies, an individual using a computer, and so on.

Stored value cards typically comprise plastic cards in the size and shape of a typical credit card, and often having a readable magnetic strip, bar code, computer/memory chip, smart chip, or the like embossed on one side. The magnetic strip is sometimes encoded with stored value account information, as defined above. In other embodiments, the strip comprises a unique identifying code which is used to access an account associated with the unique identifying number.

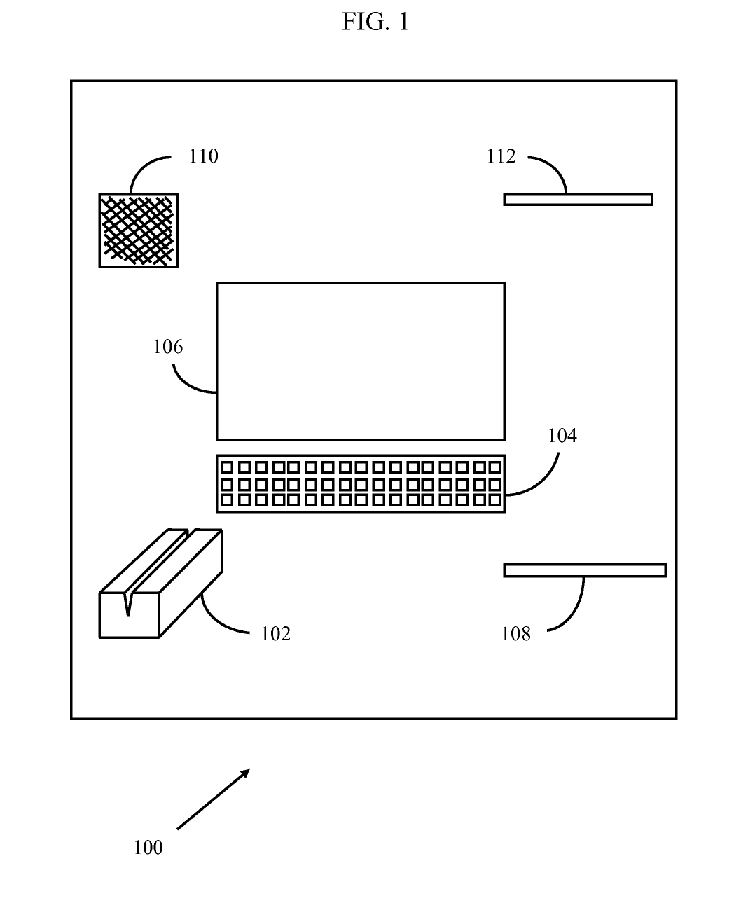

FIG. 1 illustrates an apparatus for exchanging stored value for another form(s) of value in accordance with one embodiment of the teachings of the present disclosure. It should be understood that the “another form of value” could be the same type of physical object as the form of the stored value. In other words, the term “exchanging stored value for another form of value” can comprise exchanging a first gift card redeemable at a first merchant for a second gift card redeemable at a second merchant. It should also be understood that exchanging stored value may comprise exchanging only some, or a portion of, any given stored value.

In the embodiment shown in FIG. 1, apparatus 100 comprises a kiosk, which, in general, is a transaction machine that is typically distributed publically for use by individuals. Kiosks have enjoyed a great deal of popularity in recent years, because they allow users to quickly purchase certain items without the use of human cashiers, which can sometimes slow down the purchasing process. A variety of items are typically offered by kiosks, such as lottery tickets, movie rentals, and of course, banking transactions. Apparatus 100 allows users to exchange their stored value for other forms of value. In other embodiments, the apparatus for exchanging stored value comprises a fixed or mobile personal computer or a personal wireless device, such as a wireless telephone, smart phone, or iPad.

Apparatus 100 typically comprises one or more user input devices, such as card reader 102, a keypad or keyboard 104, a touch-screen device, an optical scanner 110, an RFID receiver and/or other means for users to enter information into apparatus 100. Apparatus 100 additionally comprises a user output device 106, such as a visual display, an audio output device (such as an audio speaker), or both. In some embodiments, the elements of user input devices and user output devices are combined, such as the case of a display device that operates as a touch-screen input device or provides a “virtual” keyboard to the user. Apparatus 100 also typically comprises an alternative value output device 108, for providing a user of apparatus 100 a receipt of any transactions or providing an alternate form of value to the user. It should be understood that in other embodiments, the number, placement, and function of these features may differ from the configuration shown in FIG. 1. For example, in another embodiment, keypad 104 could be eliminated and a user touch-screen device offered in conjunction with a visual display as part of user output device 106. In yet another embodiment, card reader 102 could be eliminated and information relating to stored value cards could be entered either through keypad 104 or the touch-screen device just described. In yet another embodiment, where apparatus 100 comprises a smart phone, the user input device(s) may comprise a keypad or keyboard (virtual or otherwise), microphone, magnetic strip reader, RFID receiver, and/or optical reader, while the user output device(s) may comprise simply a display and speaker.

In a typical transaction, a user of apparatus 100, such as an individual, desires to exchange at least some stored value owned by the user for another form of value. For example, the user might possess a gift card having a certain monetary value that was given to the user as a gift from a third party. In many cases, these gift cards may only be redeemed at a merchant associated with the gift card. For example, the gift card might be redeemable only at a particular home improvement store, such as Home Depot. The user may not have a desire to shop at the particular merchant that is associated with the gift card and, therefore, may want to exchange the gift card currently in his/her possession for another form of value, such as a gift card associated with another merchant, a pre-paid debit or credit card, cash, a pre-paid phone card, etc.

In another example, the user might possess a smart phone, having wireless voice and data capabilities. In this embodiment, user's stored value may be stored within a memory or application resident on the smart phone, or accessible via the smart phone from a remote entity, such as a server or web site.

In either case, the user desires to receive as much value for his or her stored value as possible.

In one embodiment, a user wishing to exchange at least some of the user's stored value for another form of value begins a stored value exchange by providing stored value account information to apparatus 100 using one or more of the user input devices, such as card reader 102, keypad or keyboard 104, a touch-screen device, an optical scanning device 110, such as a bar-code scanner, an RFID receiver, a wi-fi or bluetooth receiver, etc. In one embodiment, the stored value account information comprises an identification code. In this case, the identification code alone is enough to identify the stored value account, an amount of the account value or balance willing to be exchanged for another form of value, one or more merchants associated with the account, an account balance, and/or an identification of an account owner. In other embodiments, the stored value account information comprises an account number, one or more merchant(s) associated with the account, an account balance, and/or an identification of an owner of the account. The stored value information could comprise other types of information as well.

The stored value account information may be provided to apparatus 100 by swiping a stored value card, having the stored value account information stored thereon, through reader 102 or providing the card to apparatus 100 via a card-capturing reader, manually entering stored value information into a keyboard, keypad, touchscreen device, or wirelessly providing the stored value account information to apparatus 100 from an object or device having the stored value account information stored thereon within proximity of an RFID receiver, wi-fi receiver, bluetooth receiver, optical scanner, or other wireless technology well known in the art.

In embodiments where apparatus 100 comprises a personal computing device, wireless telephone, smart phone, and the like, the stored value and/or stored value account information, is typically provided to apparatus 100 from a remote entity of a past transaction. For example, a user could have a smart phone that comprises stored value that was sent to the smart phone from a merchant after the user paid money to receive credit redeemable at the merchant's place of business. In another embodiment, the smart phone receives stored value account information. To redeem the stored value, the user transfers the stored value to the merchant during the check-out process by bringing the smart phone in close physical proximity to a receiver, typically located at or near the merchant's check-out stand. The receiver is configured to read the credit stored on the smart phone by electrical, RF, optical, or other means. The stored value, or stored value account information, may be displayed as a bar code or other graphical representation on the display of the smart phone or it may be transmitted by wire or wirelessly to the merchant's receiver during check-out.

After the apparatus 100 has received the stored value account information, the user output device 106 may instruct the user how to proceed for each step of the transaction, either visually if output device 106 is a display device, audibly if output device 106 is an audio device such as a speaker, or a combination of both. In one embodiment, the user provides an identification of a preferred merchant that the user would like to transact with in the future, with the hope that the user will be able to exchange the user's present stored value with an alternate form of value associated with the preferred merchant. This information can be sent in addition to the stored value account information to remote entities to alert them that the user would prefer alternative forms of value relating to the preferred merchant. In addition, or in the alternative, the apparatus 100 can send the stored value account information directly to the preferred merchant (or merchant's website or web server) in hopes of receiving an offer from the preferred merchant directly.

The stored value account information may also be validated and/or verified using a third-party service or it may be verified by merchants or businesses that specialize in stored value card exchanges, as is well known in the art. In these embodiments, the apparatus 100 sends the stored value account information to such third party service providers, merchants, or other entities. In one embodiment, after validation/verification by a third party service provider, the stored value account information may be provided to at least two entities wishing to exchange the user's stored value, rather than being provided by apparatus 100.

The user may, in one embodiment, be required to provide his or her stored value to the entity whose offer was accepted or an agent thereof. For example, the user may be required to deposit the user's stored value card into a card slot 112, capable of detecting receipt of the stored value card and providing the actual card to a storage location securely inside apparatus 100. Card slot 112 could also provide the functionality of card reader 102, so that card reader 102 could be eliminated. In this embodiment, a notification may be transmitted to the entity whose offer was accepted, alerting the entity that the user has, in fact, surrendered the stored value card to apparatus 100. In another embodiment, the user retains possession of the card after the exchange has taken place and the user physically provides the card to the entity whose offer was accepted by the user via mail or by directly visiting the entity and providing the card in person. In yet another embodiment, the user retains possession of the stored value card, but the value associated with the stored value card is transferred to the entity whose offer was accepted via electronic means. In this embodiment, a notification is sent to the particular entity and/or a third party so that the value is electronically transferred to the entity or to some other party selected by the entity. The stored value card retained by the user may have its stored value account information altered to reflect the reduction in value associated with the exchange. This would prevent the user from trying to redeem the stored value or otherwise transferring the value formally associated with the account.

### First Embodiment (Brief Description)

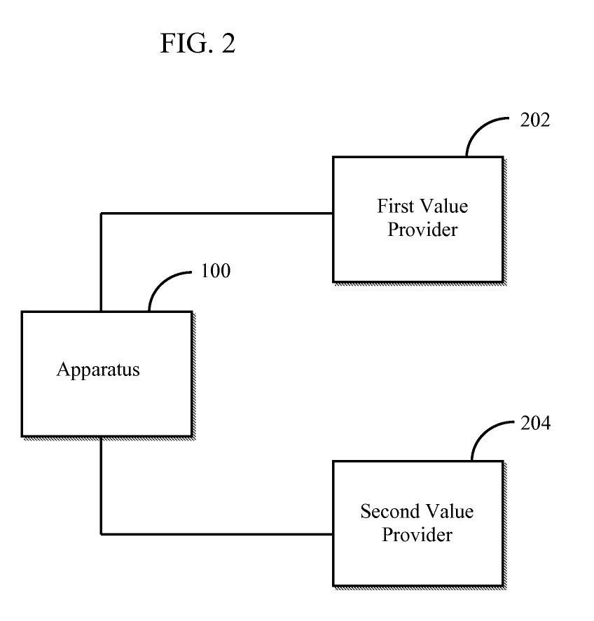

FIG. 2 illustrates a first embodiment for exchanging stored value for an alternative form(s) of value. In this embodiment, the stored value account information is sent by apparatus 100 to at least a first value provider 200. The first value provider 200 evaluates the stored value account information and sends an offer to apparatus 100 to exchange the user's stored value for alternative value. Apparatus 100 then sends a request to a second value provider 202, requesting that second value provider 202 provide a supplemental offer comprising additional value to supplement the offer received from first value provider 200. Second value provider 202 sends apparatus 100 the supplemental offer to apparatus 100. Apparatus 100 then presents a combined offer to the user, comprising the offer from first value provider 200 plus the supplemental value provided by second value provider 202. If the user accepts the combined offer, a notification is sent from apparatus 100 to the first and second value providers, alerting them that the user accepted their offers. The user's stored value is then credited or provided to first value provider 200, and first value provider 200 and second value provider 202 each provide the user with alternative forms of value, as presented in their respective offers. In one embodiment, second value provider 202 receives no value from the user's stored value or from first value provider 200. However, second value provider 202 may receive a future benefit from the user, by virtue of second value provider 202 providing certain types of supplemental value to the user, such as re-loadable debit cards, social network credits, re-loadable gasoline cards, re-loadable telephone cards, etc.

In another embodiment, first and second value providers are asked to provide offers for the user's stored value contemporaneously, or nearly so. Both value providers are sent the stored value account information. Second value provider 202 provides a supplemental value without knowing details of what first value provider 200 has offered. For example, second value provider 202 may offer a predetermined percentage of the user's stored value.

To better understand this embodiment, what follows is a specific example of how the first embodiment may be implemented. It is given for illustrative purposes only and is not intended to limit this embodiment to the specific details as follows. It should be understood that in other embodiments, a greater number of value providers could be involved in this transaction, each of the additional value providers willing to offer an alternative form of value in to the user.

In this example, a user wishes to exchange a $100 Sears gift card for a Target gift card plus a re-loadable, pre-paid debit card. The user sends stored value account information relating to the Sears gift card to first value provider 200, comprising a gift card exchange web site, in this case PlasticJungle.com. The user may also enter his preference for obtaining a Target gift card (preferred merchant information) or this information could be sent as part of the stored value account information.

PlasticJungle.com receives the user's stored value account information and preferred merchant information and, in response, checks its inventory to determine whether it owns, or can acquire, a Target gift card worth less than the $100 Sears card. If so, then PlasticJungle.com sends a first offer to apparatus 100 to exchange the user's $100 Sears card for, say, a $90 Target gift card. Apparatus 100 receives the offer from PlasticJungle.com and, in response, sends a request to second value provider 202, in this case, a debit card company. The debit card company evaluates the request from apparatus 100, which comprises at least some of the stored value account information and the value of offer provided by PlasticJungle.com and, if so desired, sends a supplemental offer to apparatus 100, willing to supplement PlasticJungle's first offer with a $10 dollar re-loadable, pre-paid debit card, without receiving equivalent value from the user or from PlasticJungle.com.

Apparatus 100 receives the supplemental offer from the debit card company and presents a combined offer to the user, comprising both the offer from PlasticJungle and the supplemental offer from the debit card company. If the user accepts the combined offer, apparatus 100 notifies PlasticJungle and the debit card company of the acceptance. The user's $100 Sears gift card is then credited or provided to PlasticJungle.com, and PlasticJungle.com provides the $90 Target gift card to the user. The debit card company provides the user the $10 re-loadable, pre-paid debit card.

### Second Embodiment (Brief Description)

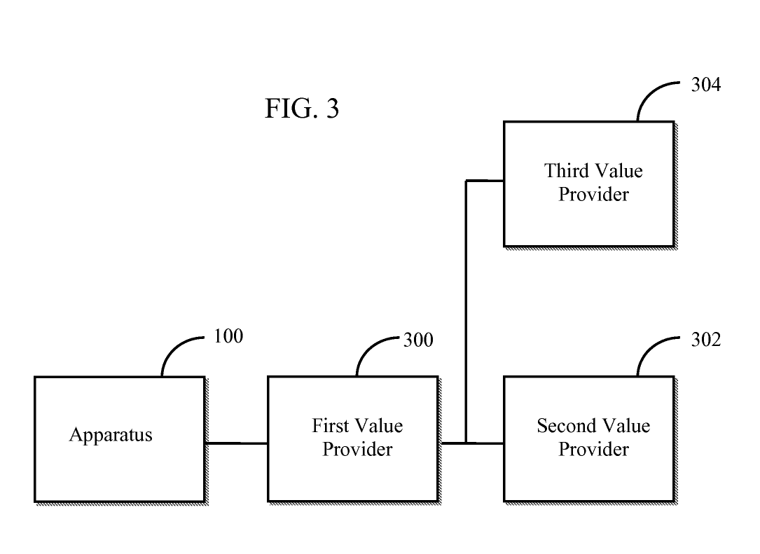

FIG. 3 illustrates another embodiment for exchanging stored value for an alternate form(s) of value. In this embodiment, stored value account information and, typically, preferred merchant information, is sent by apparatus 100 to a first value provider 300. The first value provider 300, in response to receiving the stored value account information and preferred merchant information, generates a first offer comprising an alternative form of value and an amount of value that first value provider 300 is willing to offer the user. First value provider 300 then sends a request to a second value provider 302, requesting that the second value provider 302 provide a supplemental offer to first value provider 300. The request may also be sent to one or more other value providers, such as third value provider 304. Second value provider 302 determines whether to submit an offer to first value provider 300. If it decides to do so, then a supplemental offer from second value provider 302 is sent to first value provider 300. First value provider 300 then generates a combined offer, comprising the first offer from first value provider 300 and the supplemental offer from second value provider 302. The combined offer is sent to apparatus 100 for the user to review. If the user accepts the combined offer, a notification is sent from apparatus 100 to first value provider 300 which, in turn, sends a similar notification to second value provider 302. The user's stored value is then credited or provided to first value provider 300, and first value provider 300 provides an alternative form of value to the user based on the first offer. Second value provider 302 provides the user with an alternative form of value based on the supplemental offer.

To better understand this embodiment, what follows is a specific example of how the first embodiment may be implemented. It is given for illustrative purposes only and is not intended to limit this embodiment to the specific details as follows. It should be understood that in other embodiments, a greater number of value providers could be involved in this transaction, each of the additional value providers willing to offer an alternative form of value in to the user.

In this example, a user wishes to exchange a $100 Home Depot gift card for a Chile's restaurant gift card, plus electronic credits to a social networking site, in this case, FaceBook. The user sends stored value account information relating to the Home Depot gift card to first value provider 200, comprising a stored value exchange website, in this case SwapaGift.com. The user may also enter his preference for obtaining a Chile's gift card.

SwapaGift receives the user's stored value account information and preferred merchant information and, in response, checks its inventory to determine whether it owns, or can acquire, a Chile's gift card worth less than the $100 Home Depot card. If so, then SwapaGift.com generates a first offer comprising, say, a Chile's gift card worth $92. SwapaGift.com then sends a request to a second value provider 302, in this case FaceBook, requesting that FaceBook send a supplemental offer to SwapaGift to supplement SwapaGift's $92 Chile's gift card offer. FaceBook elects to offer the user $8 in electronic FaceBook credits. This supplemental offer is sent to SwapaGift, who then generates a combined offer comprising the $92 Chile's gift card and the $8 worth of electronic credits from FaceBook. The combined offer is then sent from SwapaGift to the user via apparatus 100 for review. If the user accepts the combined offer, a notification is sent from apparatus 100 to SwapaGift which, in turn, sends a similar notification to FaceBook. The user's $100 Home Depot card is then credited or provided to SwapaGift, and SwapaGift provides the $92 Chile's gift card to the user. FaceBook credits the user's FaceBook account with the $8 in FaceBook credits. If the user does not have a FaceBook account, FaceBook can provide the electronic credit to the user in other ways, such as to create a temporary account for the user, or to send an electronic code to the user via email, SMS, or the like, for use if the user decides to create an account on FaceBook.

### Third Embodiment (Brief Description)

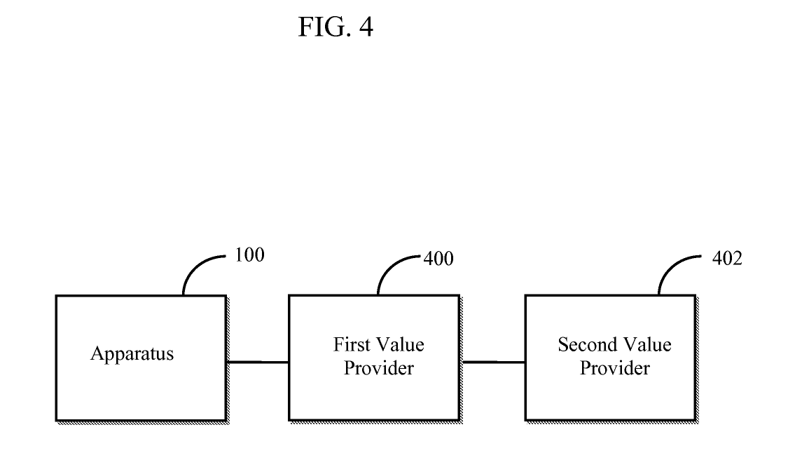

FIG. 4 shows another embodiment for exchanging stored value for alternative forms(s) of value. In this embodiment, stored value account information is sent by apparatus 100 to a first value provider 400. The first value provider 400 determines how much value it can receive by selling or exchanging the user's stored value to a third party, such as value provider 402. After first value provider 400 determines how much value it can receive for the user's stored value, first value provider 400 generates an offer to the user comprising an alternative form of value. If the user accepts the offer, a notification is sent from apparatus 100 to first value provider 400. The user's stored value is then credited or provided to first value provider 400, first value provider 400 provides the user with the offered alternative value, and first value provider 400 then sells the received stored value from the user to a third party.

To better understand this embodiment, what follows is a specific example of how the first embodiment may be implemented. It is given for illustrative purposes only and is not intended to limit this embodiment to the specific details as follows. It should be understood that in other embodiments, a greater number of value providers could be involved in this transaction, each of the additional value providers willing to offer an alternative form of value in to the user.

In this example, a user wishes to exchange a $50 Sears gift card for a re-loadable, pre-paid debit card worth at least $50. The user sends stored value account information relating to the user's stored value to first value provider 400, comprising a debit card company.

The debit card company receives the user's stored value account information and, in response, determines how much value it can receive by selling or exchanging the user's stored value to a third party, such as value provider 402, in this case, a gift card exchange web site such as CardPool.com. The debit card company may evaluate several different value providers to determine who can offer the highest price for the user's $50 Sears gift card and determines that CardPool.com offers the highest price: $45. The debit card company then generates an offer to the user comprising a $50 re-loadable, pre-paid debit card. If the user accepts the offer, a notification is sent from apparatus 100 to the debit card company. The user's $50 Sears card is then credited or provided to the debit card company, and the debit card company provides the user with the $50 re-loadable, pre-paid debit card. The debit card company then sells the received $50 Sears gift card to CardPool.com for $45.

### Fourth Embodiment (Brief Description)

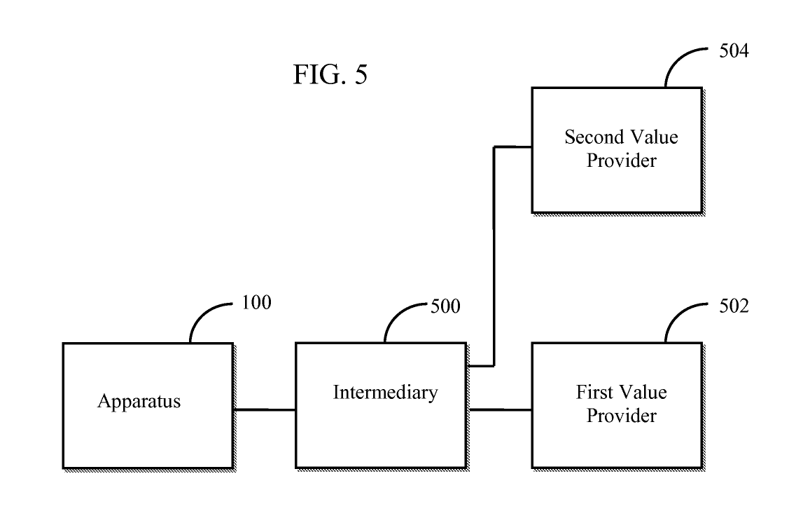

FIG. 5 illustrates another embodiment for exchanging stored value for an alternative form(s) of value. In this embodiment, a user wishing to exchange his or her stored value uses a remote user device, such as apparatus 100, to communicate with intermediary 500, which comprises any entity acting as a go-between, intermediary, third party, clearinghouse, website, web server, or other entity that provides transaction services on behalf of the user and/or value providers, such as first value provider 502 and second value provider 504. The user's stored value account information is sent to intermediary 500, and then intermediary 500 sends this information to at least first value provider 502. The first value provider 502 evaluates the stored value account information and sends an offer to intermediary 500 to exchange the user's stored value for an alternative value. Intermediary 500 then provides a request to second value provider 504, requesting that second value provider 504 provide a offer to intermediary 500 to supplement the offer received from first value provider 502. Second value provider 504 sends intermediary 500 a supplemental offer, then intermediary 500 generates a combined offer comprising the offers from first value provider 502 and second value provider 504. Intermediary 500 then sends the combined offer to apparatus 100 for the user to accept or reject. If the user accepts the combined offer, a notification is sent from apparatus 100 to intermediary 500 which, in return, alerts the first and second value providers that the user accepted their offers. The user's stored value is then credited or provided to first value provider 502 (either directly or through intermediary 500), and first value provider 502 and second value provider 504 each provide the user with alternative forms of value, as presented in their respective offers (either directly or through intermediary 500).

In another embodiment, first and second value providers are asked to provide offers for the user's stored value contemporaneously, or nearly so. Both value providers are sent the stored value account information. Second value provider 504 provides a supplemental offer without knowing details of what first value provider 502 has offered. For example, second value provider 504 may offer a predetermined percentage of the user's stored value.

To better understand this embodiment, what follows is a specific example of how the first embodiment may be implemented. It is given for illustrative purposes only and is not intended to limit this embodiment to the specific details as follows. It should be understood that in other embodiments, a greater number of value providers could be involved in this transaction, each of the additional value providers willing to offer an alternative form of value in to the user.

In this example, a user wishes to exchange a $100 Sears gift card for a Target gift card plus a re-loadable, pre-paid debit card. The user sends stored value account information relating to the Sears gift card from apparatus 100 to intermediary 500. The stored value account information may also comprise an indication of the user's preference for receiving a Target gift card or this information may be sent in a separate message. Intermediary 500 then sends the stored value account information to first value provider 502, in this case PlasticJungle.com.

PlasticJungle.com receives the user's stored value account information and preferred merchant information and, in response, checks its inventory to determine whether it owns, or can acquire, a Target gift card worth less than the $100 Sears card. If so, then PlasticJungle.com sends a first offer to intermediary 500 to exchange the user's Sears card for, for example, a $90 Target gift card. Intermediary 500 receives this offer from PlasticJungle.com and, in response, sends a request to second value provider 504 to provide a supplemental offer to intermediary 500. In this case, second value provider 504 is a debit card company. The request may comprise the stored value account information and the value of the offer from first value provider 502. The debit card company evaluates the request sent from intermediary 500 and responds with a supplemental offer to add a $10 dollar re-loadable, pre-paid debit card to PlasticJungle's offer.

Intermediary 500 receives the supplemental offer from the debit card company and generates a combined offer which is sent to apparatus 100 for the user to review. If the user accepts the combined offer, an indication of acceptance is sent from apparatus 100 to intermediary 500. In response, intermediary 500 notifies PlasticJungle.com and the debit card company of the acceptance. The user's $100 Sears gift card is then credited or provided to PlasticJungle.com (either directly or through intermediary 500) and PlasticJungle.com provides the $90 Target gift card to the user (either directly or through intermediary 500. The debit card company provides the user with a $10 re-loadable, pre-paid debit card (either directly or through intermediary 500). Intermediary 500 may, additionally, collect a small fee from the user, PlasticJungle, the debit card company, or a combination of these, for brokering the transaction.

### Fifth Embodiment (Brief Description)

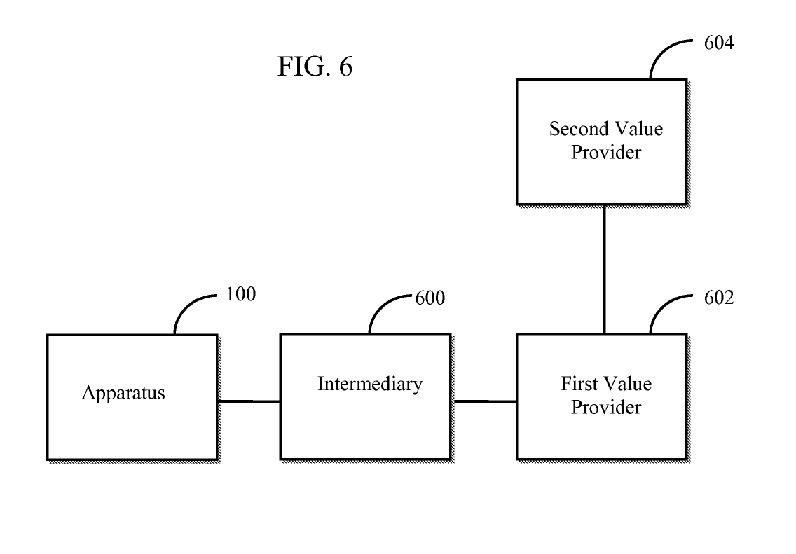

FIG. 6 illustrates yet another embodiment for exchanging stored value for an alternate form(s) of value. In this embodiment, stored value account information and, typically, preferred merchant information, is sent by a remote user device, such as apparatus 100, to intermediary 600, which comprises any entity acting as a go-between, intermediary, third party, clearinghouse, website, web server, or other entity that provides transaction services on behalf of the user and/or value providers, such as first value provider 602 and second value provider 604. Intermediary 600 then forwards the stored value account information and optional preferred merchant information to at least first value provider 602.

First value provider 602, in response to receiving the stored value account information and optional preferred merchant information, generates a first offer comprising an alternative form of value and an amount of value that first value provider 600 is willing to offer the user. First value provider 600 then sends a request to second value provider 604, asking that the second value provider 604 provide a supplemental offer supplement to first value provider 602. The request may also be sent to one or more other value providers. Second value provider 604 determines whether to submit an offer to first value provider 602. If so, then an offer from second value provider 604 is generated and sent to first value provider 602. The supplemental offer is received by first value provider 602, and then first value provider 602 generates a combined offer, comprising the first offer from first value provider 602 and the supplemental offer from second value provider 604. In another embodiment, intermediary 600 is provided the first offer and the supplemental offer and intermediary 600 generates the combined offer. In any case, the combined offer is then sent to apparatus 100 for the user to review. If the user accepts the combined offer, a notification is sent from apparatus 100 to intermediary 600, which sends a notification to first value provider 602 which, in turn, sends a notification to second value provider 604, each notification indicating the user's acceptance of the respective offers. The user's stored value is then credited or provided to first value provider 602 (either directly or through intermediary 600), and first value provider 602 and second value provider 604 each provide the user with alternative forms of value, as presented in their respective offers (either directly or through intermediary 600).

To better understand this embodiment, what follows is a specific example of how the first embodiment may be implemented. It is given for illustrative purposes only and is not intended to limit this embodiment to the specific details as follows. It should be understood that in other embodiments, a greater number of value providers could be involved in this transaction, each of the additional value providers willing to offer an alternative form of value in to the user.

In this example, a user wishes to exchange a $100 Sears gift card for a Target gift card plus a re-loadable, pre-paid debit card. The user sends stored value account information relating to the $100 Sears gift card from apparatus 100 to intermediary 600. The stored value account information may also comprise an indication of the user's preference for receiving a Target gift card or this information may be sent in a separate message. Intermediary 600 then sends the stored value account information to first value provider 602, in this case a gift card exchange web site.

The gift card exchange web site receives the user's stored value account information and optional preferred merchant information and, in response, checks its inventory to determine whether it owns, or can acquire, a Target gift card worth less than the $100 Sears card. If so, the gift card exchange web site sends a request to second value provider 604, in this case a debit card company, asking whether the debit card company will provide a supplemental offer to the gift card exchange web site. The debit card company elects to offer the user a $10 re-loadable, pre-paid debit card. This supplemental offer is sent to first value provider 602, and then both offers are sent to intermediary 600 where a combined offer is generated by intermediary 600. In another embodiment, first value provider 602 combines the two offers into a combined offer that is sent to intermediary 600. In any case, intermediary 600 then sends both offers to apparatus 100 for the user to review. If the user accepts both offers, a notification is sent from apparatus 100 to intermediary 600, which then forwards a similar acceptance notification to the gift card exchange web site which, in turn, sends an acceptance notification to the debit card company. The user's $100 Sears card is then credited or provided to the gift card exchange web site (either directly or through intermediary 600), and the gift card exchange web site provides the $90 Target gift card to the user (either directly or through intermediary 600). The debit card company provides the user with a $10 re-loadable, pre-paid debit card (either directly or through intermediary 600). Intermediary 600 may, additionally, collect a small fee from the user, the gift card exchange web site, the debit card company, or a combination of these, for brokering the transaction.

### Sixth Embodiment (Brief Description)

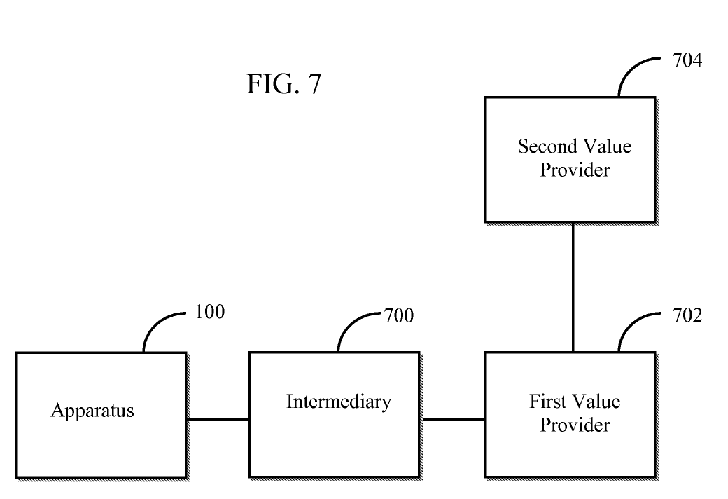

FIG. 7 shows another embodiment for exchanging stored value for alternative forms(s) of value. In this embodiment, stored value account information is sent by a remote user device, such as apparatus 100, to intermediary 700, which comprises any entity acting as a go-between, intermediary, third party, clearinghouse, website, web server, or other entity that provides transaction services on behalf of the user and/or value providers, such as first value provider 702 and second value provider 704. Intermediary 700 then forwards the stored value account information to a first value provider 702. The first value provider 702 determines how much value it can receive by selling the user's stored value to a third party, such as second value provider 704. After first value provider 702 determines how much value it can receive for the user's stored value, first value provider 702 generates an offer and sends it to intermediary 700, which then forwards the offer to apparatus 100. The offer is presented to the user and, if the user accepts the offer, an acceptance notification is sent from apparatus 100 to intermediary 700, which then forwards the acceptance notification to first value provider 702. The user's stored value is then credited or provided to first value provider 702 (either directly or through intermediary 500), and first value provider 702 provides the user with alternative value related to the offer (either directly or through intermediary 500). First value provider 702 then sells or exchanges the received stored value from the user to a third party, such as second value provider 704.

To better understand this embodiment, what follows is a specific example of how the first embodiment may be implemented. It is given for illustrative purposes only and is not intended to limit this embodiment to the specific details as follows. It should be understood that in other embodiments, a greater number of value providers could be involved in this transaction, each of the additional value providers willing to offer an alternative form of value in to the user.

In this example, a user wishes to exchange a $100 Sears gift card for a re-loadable, pre-paid debit card worth at least $100. The user sends stored value account information relating to the Sears gift card to intermediary 700. Intermediary 700 then sends a request to first value provider 702 asking first value provider 702 to provide an offer for the user's Sears gift card. The request typically comprises stored value account information relating to the $100 Sears gift card. In this example, first value provider 702 comprises a debit card company.

The debit card company receives the request from intermediary 700 and, in response, determines how much value it can receive by selling the user's $100 Sears gift card to a third party, such as second value provider 704, in this case, a gift card exchange web site. The debit card company may evaluate several different value providers to determine who can offer the highest price for the user's $100 Sears card and determines that SwapaGift.com offers the highest price: $91. The debit card company then generates an offer to intermediary 700 to exchange the user's $100 Sears gift card for a re-loadable, pre-paid debit card worth $100. The debit card company sends the offer to intermediary 700 which, in turn, sends it to apparatus 100 for review by the user. If the user accepts the offer, a notification is sent from apparatus 100 to intermediary 700, which forwards the notification to the debit card company. The user's $100 Sears card is then credited or provided to the debit card company (either directly or through intermediary 700) and the debit card company provides the user with the $100 re-loadable, pre-paid debit card (either directly or through intermediary 700). The debit card company then sells the received $100 Sears card (or credit relating thereto) to SwapaGift.com for $91.

### First Embodiment (Detailed)

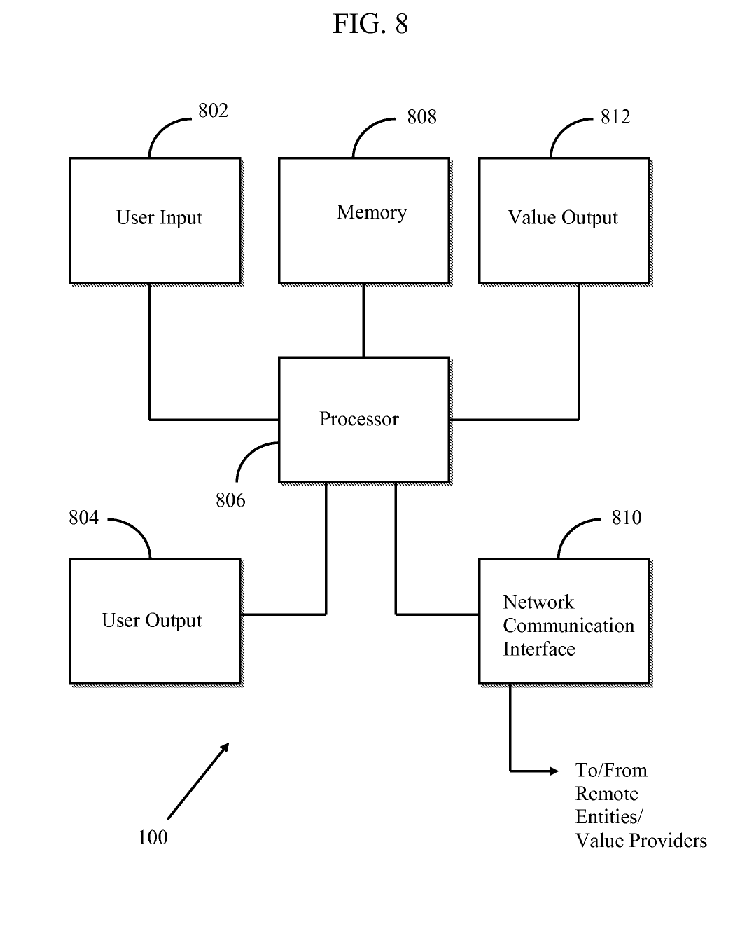

FIG. 8 is a functional block diagram illustrating the functional components of apparatus 100 used in some embodiments and adds further descriptive information and additional, related embodiments to the section above, entitled “First Embodiment (Brief Description)”. It should be understood that in some embodiments, not all of the functional blocks will be required to enable stored value exchanges and that some functionality has been omitted for clarity. In this embodiment, apparatus 100 solicits offers from at least two value providers and provides the offers to the user for acceptance.

User input device 802 generally comprises hardware and/or software necessary for the user to provide stored value account information to apparatus 100, such as a keyboard, keypad, touch-screen device, card reader, audio capture device, such as a microphone, and/or any other device for receiving electronic, RF, audio, or optical information that is well-known in the art. In another embodiment, the stored value account information is provided to apparatus 100 by a remote entity via network communication interface 810 during a prior transaction. For example, a user may have purchased an electronic credit redeemable at a particular merchant. Information relating to the electronic credit may have been provided to apparatus 100 at the time the user purchased the credit.

In one embodiment, a stored value exchange begins when the user indicates, through user input 802, that he or she would like to exchange at least a portion of his or her stored value. For example, the user may be prompted to begin a transaction by touching a touch-screen device, depressing a key on a keyboard or keypad, speaking a command, or simply by swiping or otherwise providing the stored value account information (or a stored value card itself) to the user input device 802.

The user then enters the stored value account information into apparatus 100 if it hasn't already been received in a prior transaction, as described above. The stored value account information relating to the user's stored value may comprise an numeric or alpha-numeric code that uniquely identifies the stored value to a remote verification/validation server or other remote entity. The code can be sent to a remote validation and/or verification server via network communication interface 810 to retrieve specific details regarding the stored value, such as a merchant where the stored value may be redeemed and/or an account balance. This information is sent back to apparatus 100 via network communication interface 810 and supplements the code as part of the stored value account information.

In another embodiment, stored value account information, including merchant information and account balance, may be provided to apparatus 100 directly by the user via user input device 802, either by manual entry, or by swiping or wireless means containing the stored value account information, such as a gift card, pre-paid debit card, key fob, mobile computer, mobile telephone, etc.

In any case, the stored value account information is provided to processor 806, where it is then passed to network communication interface 810. Processor 806 comprises a general-purpose microprocessor well known in the art or it may comprise a custom or semi-custom ASIC able to carry out the functionality required for a stored value exchange. Processor 806 generally performs processor-readable instructions stored in memory 808 that control most or all of the functionality of apparatus 100.

The stored value account information is received by network communication interface 810. Network communication interface 810 comprises hardware and/or software configured to send the stored value account information via a communication network, such as a wide-area network, such as the Internet, to one or more remote entities, such as web servers, websites, personal computers, or virtually any other device, fixed or mobile, that is connected to the wide-area network. In other embodiments, network communication interface 810 comprises well-known hardware and/or software for communication with remote entities via a telephone network, a fiber optic network, a satellite network, a radio network, a wireless telephone network, and/or a wireless data network, and/or any other well-known, two-way communication networks.

Network communication interface 810 sends the stored value account information to at least a remote entity, such as a value provider, such as a web server hosting a website that offers stored value card exchanges (i.e., www.PlasticJungle.com or www.SwapaGift.com). Other examples of value providers include electronic auction websites, goods and services merchants, financial institutions, such as credit and/or debit card providers, pre-paid telephone or internet providers, electronic commerce companies such as PayPal or OfferPal, or any other entity willing to exchange some form of value for the user's stored value. The first value provider may be selected by default or it may be chosen by the user using user input device 802.

The aforementioned stored value card exchange websites (www.PlasticJungle.com, www.SwapaGift.com, etc.) offer stored value card exchange services, offering to pay cash or swap a user's stored value card for another stored value card in their inventory. A user wishing to swap his or her stored value card for a different stored value card (or cash) must visit one of these types of websites via personal computer and enter their stored value account information manually, typically via a keyboard. The stored value account information is then sent to the chosen website, and then the user is typically offered a variety of alternative stored value cards from which to choose or a cash offer worth less than the value of the user's stored value. The website verifies and validates the stored value account information, including balance, then allows the user to exchange the user's stored value card with a stored value card that the website possesses in inventory, or cash. After the user selects an alternative stored value card held by the website, the user typically sends his/her stored value card to the website via mail. After the website receives the user's stored value card, it sends the alternate stored value card (or a check) to the user via mail.

The stored value account information is received by the first value provider and the first value provider determines whether to offer an alternate form of value to the user based on the stored value account information. If it decides to do so, the first value provider generates a first offer that is sent back to apparatus 100 via network communication interface 810. The first offer may be based on a number of factors, such as the availability of alternative forms of value, the value of the stored value held by the user, a merchant associated with the user's stored value, preferred merchant information indicating a merchant whom the user desires to transact future business, etc. The offer may comprise a stored value card having a different merchant associated with it than a merchant currently associated with the user's stored value and at a different monetary value associated with the stored value held by the user. Alternatively, the offer may comprise a cash, a pre-paid debit card, live event tickets, cash, sporting event tickets, movie tickets, a fuel credit, social network credits (i.e., MySpace or FaceBook), or virtually any other type of alternative value. The value of the offer is typically less than the value of the user's stored value.

The offer from the first value provider is received by network interface 810 and then provided to processor 806. Processor 806 then generates a request to a second value provider, requesting that the second value provider provide a supplemental offer to add to the offer from the first value provider. The request may include the stored value account information, details of the offer provided by the first value provider, and/or a difference between the value of the user's stored value and the value of the offer from the first value provider. In the latter case, processor 806 calculates a difference between the user's stored value and the value of the offer from the first value provider. The second value provider may comprise any entity willing to provide a supplemental offer, such as a debit card company, a merchant, a social networking site, a financial institution, etc.

In another embodiment, first and second value providers are asked to provide offers for the user's stored value contemporaneously, or nearly so. Both value providers are sent the stored value account information. The second value provider provides a supplemental offer without knowing details of what the first value provider has offered. For example, the second value provider may offer a predetermined percentage of the user's stored value as the supplemental offer.

In one embodiment, processor 806 only allows a limited time period for offers to be received, typically on the order of 1 to 30 seconds or so. The reason for this is that it is generally desirable to conclude transactions quickly, due to user expectations of quick transactions in public places where devices such as apparatus 100 are typically located.

The second value provider may be willing to provide a supplemental offer to the offer presented by the first value provider if it believes the user will provide future revenue to the second value provider. In one embodiment, the second value provider determines whether the user is an existing, or current, customer by checking a database containing customer information. If the user is not found in the database, the second value provider may be more willing to provide supplemental value to the user because of the potential of acquiring a new customer.

The supplemental offer could comprise virtually any form of value, a including coupon, pre-paid debit card, electronic credits, or a value paid to the user to view or listen to an advertisement. The advertisement could comprise a visual image, video clip, audio clip, physical or electronic voucher, etc. In one embodiment, the second value provider sends the advertisement to the first value provider, which in turn forwards the advertisement to the user. In another embodiment, the advertisement is stored within memory 808 and simply an indication of which advertisement to provide to the user is provided by the second value provider to the first value provider.

If the second value provider comprises a debit card company, the supplemental offer might comprise a re-loadable, pre-paid debit card loaded with a certain monetary value in the hope that the user will re-load the debit card after the user has exhausted the value provided by the debit card company. The debit card company typically receives revenue each time the user re-loads the debit card. In addition, debit card companies typically collect fees from merchants when the user makes purchases using the debit card.

If the second value provider comprises a social network web site, it might be willing to provide the user electronic credits that can be used to purchase game-play time, access to special web site features, bonus awards, etc. In this case, the social network web site hopes that the user will purchase further on-line credits, products, or services in the future. In yet another embodiment, the second value provider may comprise any merchant or service provider willing to provide a coupon to the user. In general, the second value provider can comprise virtually any provider of goods or services willing to offer additional value to the user.

In any case, the second value provider determines how much value to offer the user, typically based on information received from apparatus 100 relating to value of the user's stored value and the value of the offer provided by first value provider. The value of the supplemental offer from the second value provider typically provides the user with 100% of the value of the user's stored value when combined with the value from the first value provider. In other embodiments, the combined offers from the first and second value providers may provide the user with a total value of more than 100% or less than 100%. The supplemental offer from the second value provider is then sent to apparatus 100 via network interface 810.

Network interface 810 receives the supplemental offer from second value provider and, in one embodiment, processor 806 generates a combined offer comprising the first offer and the supplemental offer to be presented to the user via user output device 804. In other embodiment, both offers are presented to the user. The offers are presented to the user in the form of a visual, or audible, or both, message. At that point, the user may grant final acceptance of the offers by entering an indication of acceptance to apparatus 100 via user input device 802. After processor 806 receives the final acceptance from the user, it generally generates, and provides to network communication interface 810, an acceptance notification to be sent to the first and second value providers, alerting them that their offers were accepted by the user.

After the user has accepted the offers, the user's stored value is provided to the first value provider, either electronically, or physically providing the stored value to the first value provider. In exchange, the user receives an alternative form of value from both the first and second value providers. If the form of the alternative value comprises a tangible form, value output device 812 can be configured to dispense cash, pre-paid debit or credit cards, event tickets, vouchers, receipts, etc. In another embodiment, the user may instruct each value provider to send the alternative value electronically to the user. Examples of this include sending an electronic form of value to an account held by the user, such as the user's bank account, credit card account, debit card account, utility account, merchant account, social networking account, an e-commerce web site such as PayPal, and/or a combination of them. The electronic value could, in addition or alternatively, be sent via email, electronic message, or in an electronic format usable by an application running on a desktop or mobile computer, wireless telephone, personal mobile device such as a smart phone or iPad, or any other general or specialized electronic device. This electronic form of value may, alternatively or in addition, be sent to an account, email address or electronic device not associated directly with the user, such as a friend, relative, charity, merchant, utility company, financial institution, etc.

In one embodiment, at least one form of alternative value from either value provider is conditional. That is, the value offered is only valid upon the occurrence of a future event. For example, the future event might comprise using the value before a certain future date, re-loading a debit card a minimum number of times, loading a debit card with a value greater than a pre-determined value, visiting a merchant location or website at least a predetermined number of times, a combination of some or all of the foregoing, etc.

In yet another embodiment, one form of conditional value may comprise value provided to the user if the user agrees to watch, or listen to, an advertisement provided by a value provider. The advertisement could comprise a visual image, video clip, audio clip, physical or electronic voucher, etc. In this case, once the user has indicated that he or she has reviewed the advertisement, the conditional value to the user can be unlocked, accessed, or used.

### Second Embodiment (Detailed)

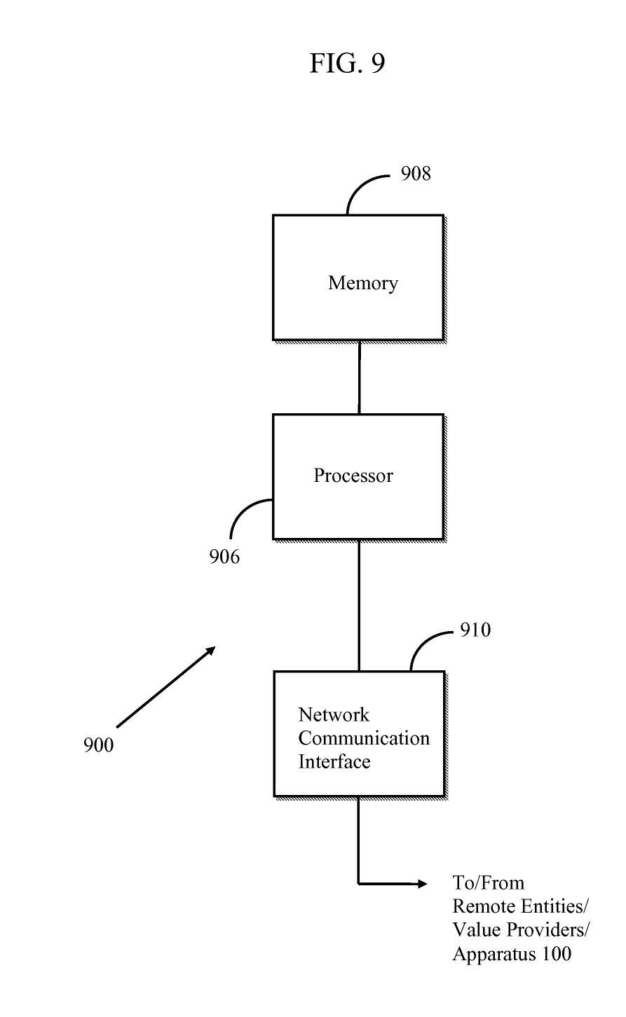

FIG. 9 is a functional block diagram illustrating the functional components of a value provider 900 used in this embodiment and adds further descriptive information and additional, related embodiments to the section above, entitled “Second Embodiment (Brief Description)”. It should be understood that in some embodiments, not all of the functional blocks will be required to enable stored value exchanges and that some functionality has been omitted for clarity. In this embodiment, value provider 900 receives stored value account information from a user, generates an offer to exchange an alternative form of value for at least a portion of the user's stored value, and solicits at least one other value provider for supplemental offer. Value provider 900 comprises, in this embodiment, a stored value exchange website, such as PlasticJungle.com or SwapaGift.com.

In this embodiment, a user begins a transaction to exchange his or her stored value by providing stored value account information relating to the user's stored value to value provider 900 using, for example, apparatus 100 as shown in FIG. 1 and described above. The stored value account information may additionally comprise an identification of one or more preferred merchant/service providers or this information may be sent in a separate message. The stored value account information is received by value provider 900 via network communication interface 910. First value provider 900 may be selected by default or it may be chosen by the user of apparatus 100.

In response to receiving the stored value account information, processor 906 determines an alternative form of value and an amount of value that first value provider 900 is willing to offer the user. For example, if the stored value account information indicates that a user holds a Best Buy gift card worth $50 and wants to exchange it for a pre-paid Shell gasoline card, processor 906 determines whether it possesses, is capable of acquiring or producing, a Shell gasoline card in amount of, generally, less than $50. Value provider 900 does this by reviewing an inventory of available forms of value currently possessed by value provider 900, typically by searching a database stored in memory 908. Ideally, the inventory will comprise at least one Shell gasoline card worth less than the user's stored value, in this case, $50. In another embodiment, first value provider 900 generates an offer comprising cash, a pre-paid debit card, or other form of value.

Processor 906 may then generate an offer to exchange the user's stored value for an alternative form of value as described above. In this example, processor 906 determines that value provider 900 owns a Shell gasoline card worth $40 and determines that it is willing to offer this card to the user in exchange for the user's $50 Best Buy gift card.

After processor 906 generates the offer, it sends a request, via network communication interface 910, to a second value provider to supplement the $40 Shell gasoline card offer. The request may also be sent to one or more other value providers. The request comprises information such as the value of the user's stored value, an amount of value being offered by value provider 900, the difference between the user's value and the value of value provider 900's offer, or it may comprise a value amount that value provider 900 believes will be acceptable to the user.

The second value provider receives the request and determines whether to submit a supplemental offer to value provider 900. The determination may be made by the second value provider evaluating whether it is worth spending money to, for example, acquire a new customer, or the likelihood of a new/existing customer spending a predetermined amount on the second value provider's goods or services. In this case, the second value provider determines whether the user is an existing, or current, customer by checking a database containing customer information. If the user is not found in the database, the second value provider may be more willing to provide supplemental value to the user because of the potential of acquiring a new customer.

In one embodiment, the second value provider determines a coupon type and coupon value as the supplemental offer. The coupon type could represent a value redeemable at a particular merchant or service provider. In yet another embodiment, the supplemental offer might comprise a monetary value paid to the user in exchange for reviewing an advertisement. The advertisement could comprise a visual image, video clip, audio clip, physical or electronic voucher, etc. In one embodiment, the second value provider sends the advertisement to value provider 900 to forward to the user. In another embodiment, the advertisement is stored within memory 908 and simply an indication of which advertisement to provide to the user is provided by the second value provider. In any case, if the second value provider decides to submit a supplemental offer, it is generated and then sent to value provider 900 via network communication interface 910.

In an embodiment where second and/or subsequent value providers are solicited for a supplemental offer in addition to the offer generated by first value provider 900, offers from those entities could be received by via network communication interface 910 and the highest offer selected. Or, in another embodiment, the offers from each of the value providers may be aggregated. For example, a second value provider might offer a $5 coupon to the user while a third value provider might offer $10 in social networking credits. In this case, the supplemental offer would comprise both the $5 and $10 offers.

Each value provider is typically free to craft their own form of value. In other words, each entity is generally free to offer whatever form of value they choose to the user in exchange for at least some of the value associated with the user's stored value. The value may take any form, including a pre-paid debit card, a pre-paid credit card, a pre-paid phone card, movie tickets, cash, coupons, live entertainment tickets such as sporting event tickets, concert tickets, or theater tickets, travel vouchers, fuel credit, merchandise, social network credits, (i.e., MySpace or FaceBook), e-commerce credit (such as that found in services such as PayPal), or anything else of value.

In one embodiment, processor 906 only allows a limited time period for offers to be received, typically on the order of 1 to 30 seconds or so. The reason for this is that it is generally desirable to conclude transactions quickly, due to user expectations of quick transactions in public places where devices such as apparatus 100 are typically located.

After the value provider 900 has received one or more supplemental offers, processor 906 generates a combined offer to the user of apparatus 100 comprising the offer generated from value provider 900 and the one or more supplemental offers. Typically, the total value of the combined offer will be equal to the value of the user's stored value. In other embodiments, the combined offer could be less than, or even greater than, the value of the user's stored value. In other embodiment, the two offers are not combined by processor 906, but forwarded to apparatus 100 separately. In this example, it will be assumed that processor 906 generates a combined offer.

The combined offer is sent to the user via network communication interface 910. It is typically provided to the user in the form of a visual, audible, or both, message via apparatus 100. At that point, the user may grant acceptance of the combined offer by entering an indication of acceptance to apparatus 100 via a user input device. The indication of acceptance is transmitted to network communication interface 910, where it is provided to processor 906. Processor 906 then generates a similar indication of acceptance for the second value provider and sends it to network communication interface 910 for transmission to the second value provider.

After all parties have been notified of the user's acceptance of the offers, the user's stored value is provided to value provider 900, either electronically, or physically providing the stored value to the first value provider. In exchange, the user receives an alternative form of value from both the first and second value providers. In one embodiment, the user may instruct each value provider on how to provide the alternative value to the user. Examples of this include sending an electronic form of value to an account held by the user, such as the user's bank account, credit card account, debit card account, utility account, merchant account, social networking account, an e-commerce web site such as PayPal, or a combination of them. The electronic value could, in addition or alternatively, be sent via email, electronic message, or in an electronic format usable by an application running on a desktop or mobile computer, wireless telephone, personal mobile device such as a smart phone or iPad, or any other general or specialized electronic device. This electronic form of value may, alternatively or in addition, be sent to an account, email address or electronic device not associated directly with the user, such as a friend, relative, charity, merchant, utility company, financial institution, etc.

In one embodiment, at least one form of alternative value from either value provider is conditional. That is, the value offered is only valid upon the occurrence of a future event. For example, the future event might comprise using the value before a certain future date, re-loading a debit card a minimum number of times, loading a debit card with a value greater than a pre-determined value, visiting a merchant location or website at least a predetermined number of times, a combination of some or all of the foregoing, etc.

In yet another embodiment, one form of conditional value may comprise value provided to the user if the user agrees to watch, or listen to, an advertisement provided by a value provider. The advertisement could comprise a visual image, video clip, audio clip, physical or electronic voucher, etc. In this case, once the user has indicated that he or she has reviewed the advertisement, the conditional value to the user can be unlocked, accessed, or used.

### Third Embodiment (Detailed)

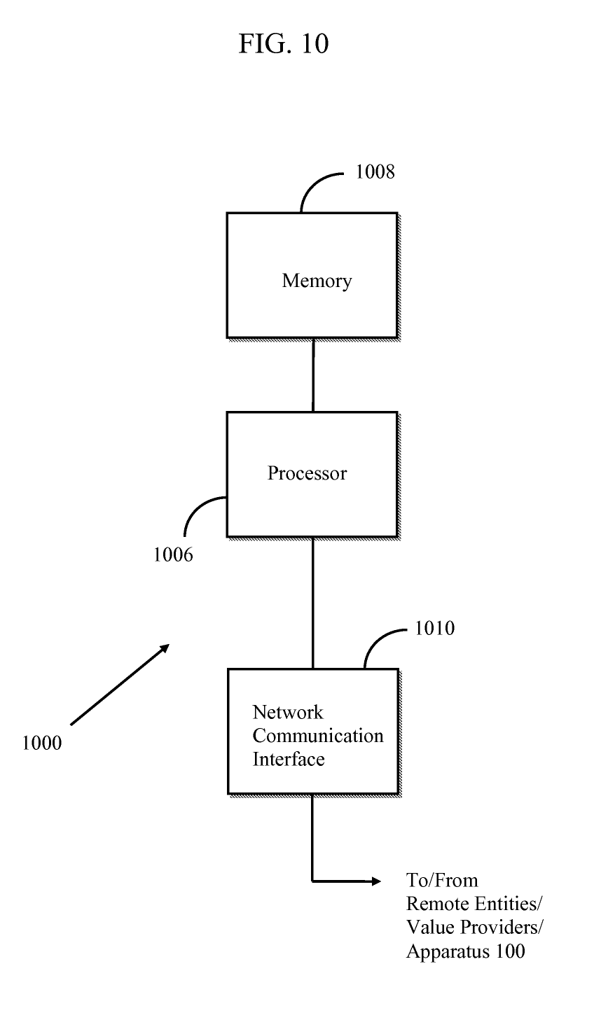

FIG. 10 is a functional block diagram illustrating the functional components of a value provider 1000 used in this embodiment and adds further descriptive information and additional, related embodiments to the section above, entitled “Third Embodiment (Brief Description)”. It should be understood that in some embodiments, not all of the functional blocks will be required to enable stored value exchanges and that some functionality has been omitted for clarity. In this embodiment, value provider 1000 receives stored value account information from a user, determines a market value for the user's stored value, generates an offer to exchange the user's stored value for an alternative form of value, typically a value greater than or equal to the actual value of the user's stored value (i.e., face value, remaining balance, etc). If the offer is accepted, the user provides the stored value to value provider 1000, value provider 1000 provides the user with the alternative value, and value provider 1000 sells or otherwise exchanges the stored value to a third party at the market value. Value provider 1000 comprises a debit card company in the example that follows, although value provider 1000 may comprise any entity willing to exchange a user's stored value for an alternative form of value.

In this embodiment, a user begins a transaction to exchange at least a portion of his or her stored value by providing stored value account information relating to the user's stored value to value provider 1000 using, for example, apparatus 100 as shown in FIG. 1 and described above. The stored value account information may additionally comprise an identification of one or more preferred merchant/service providers or this information may be sent in a separate message. The stored value account information is received via network communication interface 1010. The first value provider may be selected by default or it may be chosen by the user.

In response to receiving the stored value account information, processor 1006 determines a market value of the user's stored value. In other words, processor 1006 determines how much value can be receive from a third party in exchange for the user's stored value. Third parties comprise any entity willing to exchange the stored value for an alternative form of value, typically cash or equivalent, such as value providers, individuals, gift card exchange service providers, financial institutions, etc. Processor 1006 may send an inquiry to one or more third parties via network communication interface 1006 to determine how much value could be received from one of these third parties. For example, if the user's stored value account information indicates that the stored value comprises a $60 pre-paid telephone card, processor 1006 may determine that this card can be sold for $45 to a particular website, and that other websites offer less than $45. Processor 1006 may keep a database of popular forms of value in a database and update the market values of the value at certain time intervals. For example, a database could be stored within memory 1008 relating to market values of 10 of the most popular retailers, updated each week by processor 1006 performing an inquiry to a variety of websites.

After processor 1006 determines how much value it can receive for the user's stored value, processor 1006 generates an offer to the user comprising an alternative form of value and sends the offer to the user via network communication interface 1010. For example, the offer to the user might comprise a re-loadable, pre-paid debit card worth an amount less than, equal to, or greater than, the value of the user's stored value. For instance, using the $60 pre-paid telephone card cited above, processor 1006 might offer the user a $60 re-loadable, pre-paid debit card.

The offer from processor 1006 is presented to the user in the form of a visual, audible, or both, message via apparatus 100. At that point, the user may grant acceptance of the offer by entering an indication of acceptance to apparatus 100 via a user input device. The indication of acceptance is transmitted to network communication interface 1010, where it is provided to processor 1006. The user's stored value is then provided to value provider 1000, either electronically, or physically providing the stored value to value provider 1000. In exchange, the user receives an alternative form of value from value provider 1000. In one embodiment, the user may instruct value provider 1000 on how to provide the alternative value to the user. Examples of this include printing a voucher, mailing a physical form of value to the user, such as a gift card, debit card, merchandise, etc., sending an electronic form of value to an account held by the user, such as the user's bank account, credit card account, debit card account, utility account, merchant account, social networking account, an e-commerce web site such as PayPal, or a combination of them. The electronic value could, in addition or alternatively, be sent via email, electronic message, or in an electronic format usable by an application running on a desktop or mobile computer, wireless telephone, personal mobile device such as a smart phone or iPad, or any other general or specialized electronic device. This electronic form of value may, alternatively or in addition, be sent to an account, email address or electronic device not associated directly with the user, such as a friend, relative, charity, merchant, utility company, financial institution, etc.

After value provider 1000 receives the user's stored value, it then sells otherwise exchanges the stored value to a third party identified earlier in the process to recoup as much value as possible.

In some embodiments, at least a portion of the alternative value from value provider 1000 is conditional. That is, at least a portion of the value provided by value provider 1000 is only valid upon the occurrence of a future event. For example, the future event might comprise using the value before a certain future date, re-loading a debit card a minimum number of times, loading a debit card with a value greater than a pre-determined value, visiting a merchant location or website at least a predetermined number of times, a combination of some or all of the foregoing, etc.

In yet another embodiment, one form of conditional value may comprise value provided to the user if the user agrees to watch, or listen to, an advertisement provided by a value provider. The advertisement could comprise a visual image, video clip, audio clip, physical or electronic voucher, etc. In this case, once the user has indicated that he or she has reviewed the advertisement, the conditional value to the user can be unlocked, accessed, or used.

### Fourth Embodiment (Detailed)

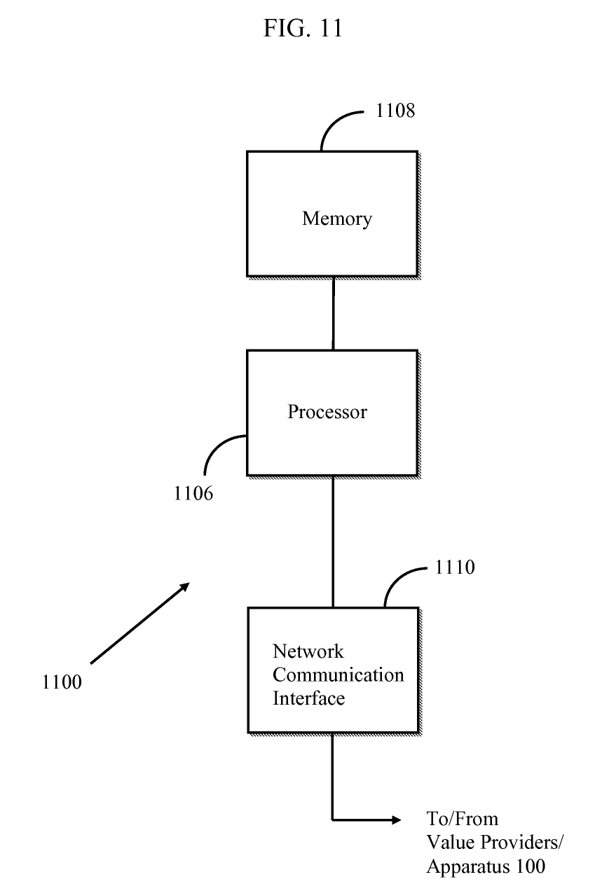

FIG. 11 is a functional block diagram illustrating the functional components of an intermediary 1100 used in this embodiment and adds further descriptive information and additional, related embodiments to the section above, entitled “Fourth Embodiment (Brief Description)”. It should be understood that in some embodiments, not all of the functional blocks will be required to enable stored value exchanges and that some functionality has been omitted for clarity. In this embodiment, a user wishing to exchange at least a portion of his or her stored value uses a remote user device, such as apparatus 100, to communicate with an intermediary 1100, which in turn contacts at least two value providers to generate a combined offer to the user in exchange for the user's stored value. Intermediary 1100 comprises any entity acting as a go-between, intermediary, third party, clearinghouse, website, web server, or other entity that provides transaction services on behalf of the user and/or value providers, such as a first value provider and a second value provider. Intermediary 1100 could, alternatively or in addition, comprise a value provider.

Like the other embodiments discussed previously, a user's stored value account information is sent, this time to intermediary 1100, via network communication interface 1110. Network communication interface 1110 comprises hardware and/or software configured to send the stored value account information via a communication network , such as a wide-area network, such as the Internet, to one or more remote entities, such as web servers, websites, personal computers, or virtually any other device, fixed or mobile, that is connected to the wide-area network. In other embodiments, network communication interface 1110 comprises well-known hardware and/or software for communication with remote entities via a telephone network, a fiber optic network, a satellite network, a radio network, a wireless telephone network, and/or a wireless data network, and/or any other well-known, two-way communication networks.

Network communication interface 1110 sends the stored value account information to at least a first value provider, such as a web server hosting a website that offers stored value card exchanges (i.e., www.PlasticJungle.com or www.SwapaGift.com). Other examples of value providers include electronic auction websites, goods and services merchants, financial institutions, such as credit and/or debit card providers, pre-paid telephone or internet providers, electronic commerce companies such as PayPal OfferPal, or any other entity willing to exchange some form of value for the user's stored value. The first value provider may be selected by default or it may be chosen by the user.

The aforementioned stored value card exchange websites (www.PlasticJungle.com or www.SwapaGift.com) offer stored value card exchange services, offering to pay cash or swap a user's stored value card for another stored value card in their inventory. A user wishing to swap his or her stored value card for a different stored value card (or cash) must visit one of these types of websites via personal computer and enter their stored value account information manually, typically via a keyboard. The stored value account information is then sent to the chosen website, and then the user is typically offered a variety of alternative stored value cards from which to choose. The website verifies and validates the stored value account information, including balance, then allows the user to exchange the user's stored value card with a stored value card that the website possesses in inventory. After the user selects an alternative stored value card held by the website, the user typically sends his/her stored value card to the website via mail. After the website receives the user's stored value card, it sends the alternate stored value (or cash or equivalent) that the user selected via mail to the user.

The stored value account information is received by the first value provider and the first value provider determines whether to offer an alternate form of value to the user based on the stored value account information. If it decides to do so, the first value provider generates a first offer that is sent back to intermediary 1100 via network communication interface 1110. The first offer may be based on a number of factors, such as the availability of alternative forms of value, the value of the stored value held by the user, a merchant associated with the user's stored value, preferred merchant information, etc. The offer may comprise a stored value card having a different merchant associated with it than a merchant currently associated with the user's stored value and at a different monetary value associated with the stored value held by the user. Alternatively, the offer may comprise cash (or the equivalent), a debit card, live event tickets, cash, sporting event tickets, movie tickets, a fuel credit, social network credits (i.e., MySpace or FaceBook), or virtually any other type of value.

The offer from the first value provider is received by network interface 1110 and then provided to processor 1106. Processor 1106 then generates a request to a second value provider, requesting that the second value provider provide a supplemental offer to add to the offer from the first value provider. The request may include the stored value account information, details of the offer provided by the first value provider, and/or a difference between the value of the user's stored value and the value of the offer from the first value provider. In the latter case, processor 1106 calculates a difference between the user's stored value and the value of the offer from the first value provider. The second value provider may comprise any entity willing to provide a supplemental offer, such as a debit card company, a merchant, a social networking site, a financial institution, etc.

In another embodiment, first and second value providers are asked by intermediary 1100 to provide offers for the user's stored value contemporaneously, or nearly so. Both value providers are sent the stored value account information. The second value provider provides a supplemental offer without knowing details of what the first value provider has offered. For example, the second value provider may offer a predetermined percentage of the user's stored value as the supplemental offer.

In one embodiment, processor 1106 only allows a limited time period for offers to be received, typically on the order of 1 to 30 seconds or so. The reason for this is that it is generally desirable to conclude transactions quickly, due to user expectations of quick transactions in public places where devices such as apparatus 100 are typically located.

The second value provider may be willing to provide a supplemental offer to the offer presented by the first value provider if it believes the user will provide future revenue to the second value provider. The supplemental offer could comprise virtually any form of value, including coupons or a value paid to the user for reviewing an advertisement. The advertisement could comprise a visual image, video clip, audio clip, physical or electronic voucher, etc. In one embodiment, the second value provider sends the advertisement to the intermediary, which in turn forwards the advertisement to the user. In another embodiment, the advertisement is stored within memory 1108 and simply an indication of which advertisement to provide to the user is provided by the second value provider to intermediary 1100.

If the second value provider comprises a debit card company, the supplemental offer might comprise a pre-paid debit card loaded with a certain monetary value in the hope that the user will re-load the debit card after the user has exhausted the value provided by the debit card company. The debit card company typically receives revenue each time the user re-loads the debit card. In addition, debit card companies typically collect fees from merchants when the user makes purchases using the debit card. If the second value provider comprises a social network web site, it might be willing to provide the user electronic credits that can be used to purchase game-play time, access to special web site features, bonus awards, etc. In this case, the social network web site hopes that the user will purchase further on-line credits, products, or services in the future. In yet another embodiment, the second value provider may comprise any merchant or service provider willing to provide a coupon to the user. In general, the second value provider can comprise virtually any provider of goods or services willing to offer additional value to the user.

In any case, the second value provider determines how much value to offer the user, typically based on information received from intermediary 1100 relating to value of the user's stored value and the value of the offer provided by the first value provider. The value of the offer from the second value provider typically provides the user with 100% of the value of the user's stored value when combined with the value from the first value provider. In other embodiments, the offer from the second value may provide the user with a total value of more than 100% or less than 100% when combined with the value from the first value provider. In any case, the offer from the second value provider is then sent to intermediary 1100 via network interface 1110.

Network interface 1110 receives the supplemental offer from second value provider and, in one embodiment, processor 1106 generates a combined offer comprising the first offer and the supplemental offer to be presented to the user via user output device 1104. In other embodiment, both offers are presented to the user. The offer are then provided to network interface 1110, where it is then sent to the user for approval. The user receives the offers via a device such as apparatus 100, discussed above, typically in the form of a visual, or audible, or both, message. At that point, the user may grant final acceptance of the offers by entering an indication of acceptance to apparatus 100 via user input device 1102. At that point, the user may grant final acceptance of the combined offer by entering an indication of acceptance to apparatus 100. The indication of acceptance is then sent to intermediary 1100, where it is received by network communication interface 1110 and provided to processor 1106. Processor 1106, in turn, generates an acceptance message that is sent to first and second value providers, alerting them that their offers were accepted by the user.

After the user has accepted the offers, the user's stored value is provided to the first value provider (either directly or through intermediary 1100), either electronically, or physically providing the stored value to the first value provider, as discussed in previous embodiments. In exchange, the user receives an alternative form of value from both the first and second value providers (either directly or through intermediary 1100).

In one embodiment, at least one form of alternative form of value, from either value provider, is conditional. That is, the value offered is only valid upon the occurrence of a future event. For example, the future event might comprise using the value before a certain future date, re-loading a debit card a minimum number of times, loading a debit card with a value greater than a pre-determined value, visiting a merchant location or website at least a predetermined number of times, a combination of some or all of the foregoing, etc.

In yet another embodiment, one form of conditional value may comprise value provided to the user if the user agrees to watch, or listen to, an advertisement provided by a value provider. The advertisement could comprise a visual image, video clip, audio clip, physical or electronic voucher, etc. In this case, once the user has indicated that he or she has reviewed the advertisement, the conditional value to the user can be unlocked, accessed, or used.

### Fifth Embodiment (Detailed)

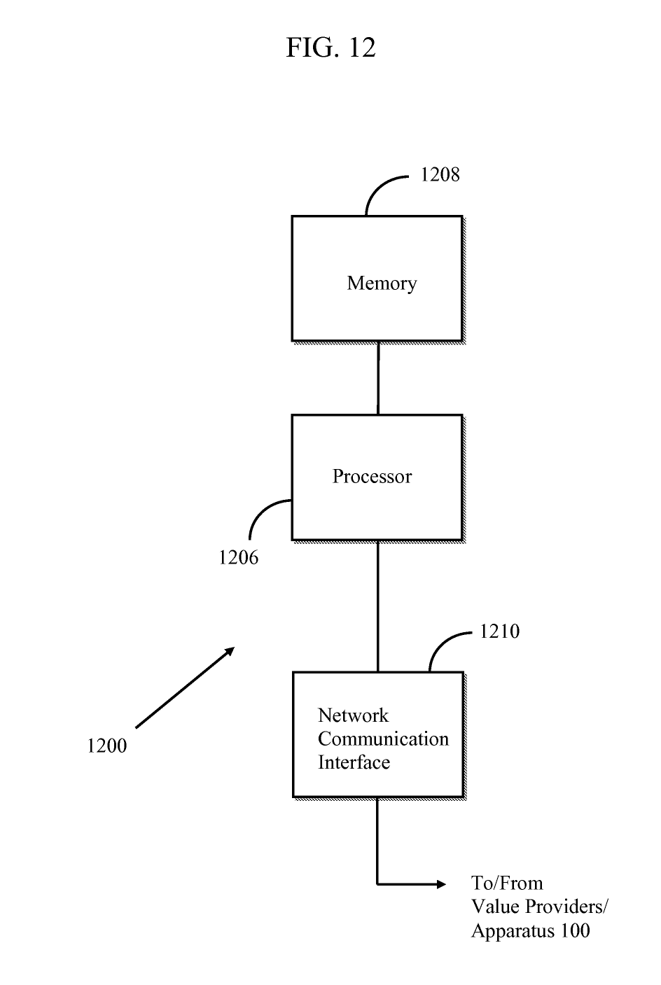

FIG. 12 is a functional block diagram illustrating the functional components of an intermediary 1200 used in this embodiment and adds further descriptive information and additional, related embodiments to the section above, entitled “Fifth Embodiment (Brief Description)”. It should be understood that in some embodiments, not all of the functional blocks will be required to enable stored value exchanges and that some functionality has been omitted for clarity. In this embodiment, a user wishing to exchange at least a portion of his or her stored value uses a remote user device, such as apparatus 100, to communicate with an intermediary 1200, which in turn contacts a first value provider to request an offer for the user's stored value. The first value provider then solicits a second value provider for supplemental value, then the two offers are presented to intermediary 1200. Intermediary 1200 then sends the offers to the user for approval.

In this embodiment, a user begins a transaction to exchange his or her stored value by providing stored value account information relating to the user's stored value to intermediary 1200 using, for example, apparatus 100 as shown in FIG. 1 and described above. Intermediary 1200 comprises any entity acting as a go-between, intermediary, third party, clearinghouse, website, web server, or other entity that provides transaction services on behalf of the user and/or value providers, such as a first value provider and second value provider. Intermediary 1200 could, alternatively or in addition, comprise a value provider.

The stored value account information may additionally comprise an identification of one or more preferred merchant/service providers or this information may be sent in a separate message. The stored value account information is received via network communication interface 1210 and sent to processor 1206. Processor 1206 generates a request for a first offer from a first value provider, to exchange the user's stored value for an alternative form of value. The request typically comprises a value of the user's stored value, an identification of a merchant associated with the stored value, and/or preferred merchant information, an account number, etc. The request is provided to network communication interface 1210 where it is sent to the first value provider. An identification of the first value provider may be stored within memory 1208 and selected by default by processor 1206 or it may be chosen by the user and provided to intermediary 1200 either within the stored value account information or in a separate message.

In response to the request to provide an alternative form of value to the user, the first value provider determines an alternative form of value and an amount of value that the first value provider is willing to offer the user. For example, if the stored value account information indicates that a user holds a Best Buy gift card worth $50 and wants to exchange it for a pre-paid Shell gasoline card, the first value provider may determine whether it possesses, is capable of acquiring or producing, a Shell gasoline card in amount of, generally, less than $50. The first value provider does this by reviewing an inventory of available forms of value currently possessed by the first value provider, typically by searching a database stored in memory. Ideally, the inventory will comprise at least one Shell gasoline card worth less than the user's stored value, in this case, $50. In another embodiment, the first value provider generates an offer comprising cash, a pre-paid debit card, or other form of value.

The first value provider then sends a request to a second value provider to supplement the $40 Shell gasoline card (or other form of value). The request may also be sent to one or more other value providers. The request comprises information such as the value of the user's stored value, an amount of value being offered by the first value provider, the difference between the user's value and the value of the first value provider's offer, and/or it may comprise a value amount that the first value provider believes will be acceptable to the user, among other things.

The second value provider receives the request and determines whether to submit a supplemental offer to the first value provider. The determination is made by the second value provider evaluating whether it is worth spending money to, for example, acquire a new customer, or the likelihood of a new/existing customer spending a predetermined amount on the second value provider's goods or services. In this case, the second value provider determines whether the user is an existing, or current, customer by checking a database containing customer information. If the user is not found in the database, the second value provider may be more willing to provide supplemental value to the user because of the potential of acquiring a new customer.

In one embodiment, the second value provider determines a coupon type and coupon value as the supplemental offer. The coupon type could represent a value redeemable at a particular merchant or service provider. In yet another embodiment, the supplemental offer might comprise a monetary value paid to the user in exchange for reviewing an advertisement. The advertisement could comprise a visual image, video clip, audio clip, physical or electronic voucher, etc. In one embodiment, the second value provider sends the advertisement to the first value provider which, in turn, forwards to intermediary 1200. Intermediary 1200 then forwards the advertisement to the user for review. In another embodiment, the advertisement is stored within memory 1208 and simply an indication of which advertisement to provide to the user is provided by the second value provider to intermediary 1200 via the first value provider. In any case, if the second value provider decides to submit a supplemental offer, it is generated and then sent to first value provider.

In an embodiment where other value providers are solicited for a supplemental offer in addition to the second value provider, offers from those entities could be received by the first value provider and the highest offer selected. Or, in another embodiment, the offers from each of the value providers may be aggregated by the first value provider. For example, the second value provider might offer a $5 coupon as a supplemental offer to the user while a third value provider might offer $10 in social networking credits as a supplemental value. In this case, the total supplemental offer would comprise both the $5 and $10 offers.

In general, each value provider is typically free to craft their own form of value.

In other words, each entity is generally free to offer whatever form of value they choose to the user in exchange for at least some of the value associated with the user's stored value. The value may take any form, including a pre-paid debit card, a pre-paid credit card, a pre-paid phone card, movie tickets, cash, live entertainment tickets such as sporting event tickets, concert tickets, or theater tickets, travel vouchers, fuel credit, merchandise, social network credits, (i.e., MySpace or FaceBook), e-commerce credit (such as that found in services such as PayPal), or anything else of value.

In one embodiment, processor 1206 only allows a limited time period for offers to be received, typically on the order of 1 to 30 seconds or so. The reason for this is that it is generally desirable to conclude transactions quickly, due to user expectations of quick transactions in public places where devices such as apparatus 100 are typically located.

After the first value provider has received one or more supplemental offers, it provides the offer generated by processor 1206 plus the one or more received supplemental offers to intermediary 1200. In another embodiment, the offers from the first value provider and the supplemental offer(s) are combined into a combined offer. The offers are received by network communication interface 1210 and provided to processor 1206. Processor 1206, in turn, forwards the offers, either separately or combined, to the user of apparatus 100 via network communication interface 1210. Typically, the total value of the offer from the first value provider and the supplemental offer(s) will be equal to the value of the user's stored value. In other embodiments, the value of the two offers could be less than, or even greater than, the value of the user's stored value.

The offers are typically provided to the user in the form of a visual, audible, or both, message via apparatus 100. At that point, the user may grant acceptance of the offers by entering an indication of acceptance to apparatus 100 via a user input device. The indication of acceptance is transmitted to intermediary 1200 via network communication interface 1210, where it is provided to processor 1206. Processor 1206 then generates an indication of acceptance and sends it to the first value provider via network communication interface 1210. The first value provider then sends a similar acceptance notification to the second value provider.

After all parties have been notified of the user's acceptance of the offers, the user's stored value is provided to the first value provider (either directly or through intermediary 1200), either electronically, or physically providing the stored value to the first value provider. In exchange, the user receives an alternative form of value from both the first and second value providers (either directly or through intermediary 1200). In one embodiment, the user may instruct each value provider on how to provide the alternative value to the user. Examples of this include sending an electronic form of value to an account held by the user, such as the user's bank account, credit card account, debit card account, utility account, merchant account, social networking account, an e-commerce web site such as PayPal, or a combination of them. The electronic value could, in addition or alternatively, be sent via email, electronic message, or in an electronic format usable by an application running on a desktop or mobile computer, wireless telephone, personal mobile device such as a smart phone or iPad, or any other general or specialized electronic device. This electronic form of value may, alternatively or in addition, be sent to an account, email address or electronic device not associated directly with the user, such as a friend, relative, charity, merchant, utility company, financial institution, etc.

In one embodiment, at least one form of alternative value from either value provider is conditional. That is, the value offered is only valid upon the occurrence of a future event. For example, the future event might comprise using the value before a certain future date, re-loading a debit card a minimum number of times, loading a debit card with a value greater than a pre-determined value, visiting a merchant location or website at least a predetermined number of times, a combination of some or all of the foregoing, etc.

In yet another embodiment, one form of conditional value may comprise value provided to the user if the user agrees to watch, or listen to, an advertisement provided by a value provider. The advertisement could comprise a visual image, video clip, audio clip, physical or electronic voucher, etc. In this case, once the user has indicated that he or she has reviewed the advertisement, the conditional value to the user can be accessed and used.

### Sixth Embodiment (Detailed)

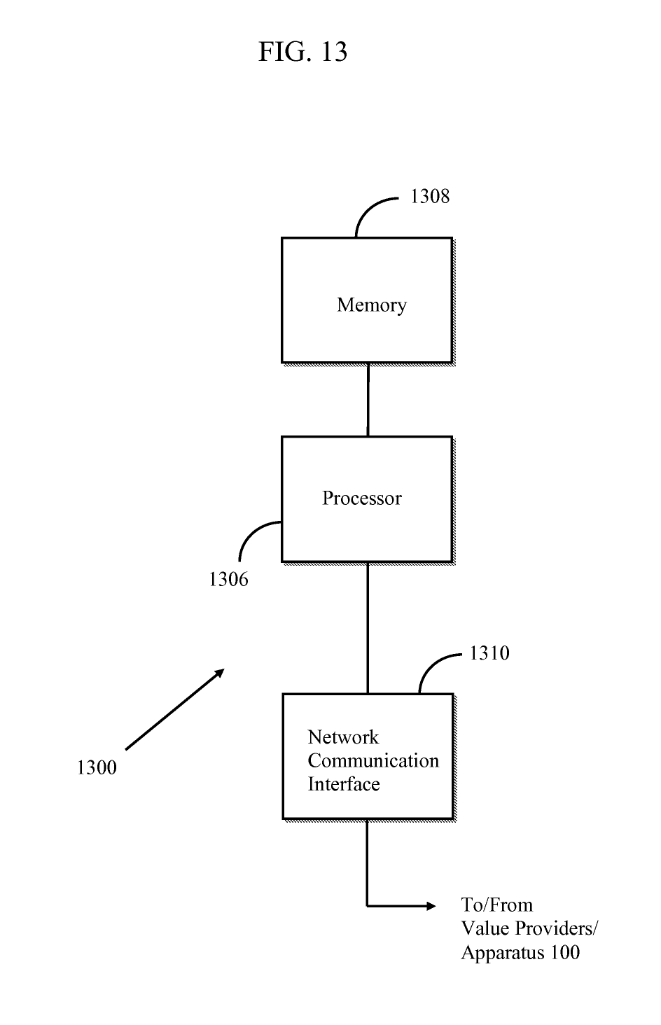

FIG. 13 is a functional block diagram illustrating the functional components of an intermediary 1300 used in this embodiment and adds further descriptive information and additional, related embodiments to the section above, entitled “Sixth Embodiment (Brief Description)”. It should be understood that in some embodiments, not all of the functional blocks will be required to enable stored value exchanges and that some functionality has been omitted for clarity. In this embodiment, a user wishing to exchange at least a portion of his or her stored value for an alternate form(s) of value interacts with intermediary 1300, which generates a request to a value provider to provide an alternative form of value for the user's stored value. The value provider determines a market value of the user's stored value and, in response, submits an offer to intermediary 1300 for the user's stored value, typically in an amount equal to the actual value of the user's stored value (i.e., face value, remaining balance, etc). The offer is forward by intermediary 1300 to the user and, if accepted, the user provides his or her stored value to the value provider, the value provider sends the alternative value to the user, and the value provider sells the stored value for its market value.

In this embodiment, a user begins a transaction to exchange his or her stored value by providing stored value account information relating to the user's stored value to intermediary 1300 using, for example, a remote user device such as apparatus 100, as shown in FIG. 1 and described above. Intermediary 1300 comprises any entity acting as a go-between, intermediary, third party, clearinghouse, website, web server, or other entity that provides transaction services on behalf of the user and/or value providers, such as a first value provider and second value provider. Intermediary 1300 could, alternatively or in addition, comprise a value provider. In any case, the stored value account information is received via network communication interface 1310 and provided to processor 1306.

In response to receiving the stored value account information, processor 1306 generates a request to at least a first value provider to submit an offer for the user's stored value. The request is received by at least the first value provider and the first value provider determines how much value can be received from a third party (such as a second value provider, individual, merchant, financial institution, etc.) for the user's stored value. The determination may be made by the first value provider sending an inquiry to at least one third party to determine how much value could be expected in exchange for the user's stored value. For example, if the user's stored value comprises a $60 pre-paid telephone card, processor 1306 may determine that this can be sold for $45 to a particular website, and that other websites offer less than $45. The first value provider can store information relating to third parties other value providers, such as websites, URLs, or other identification information enabling the first value provider to locate and determine a second value provider offering the best price for the user's stored value. In another embodiment, the first value provider obtains such information at regular time intervals and stores such information in a database, such that the first value provider knows roughly how much the user's stored value is worth, without the need to send an inquiry to other value providers each time a request to provide an offer is received from intermediary 1300.

After the first value provider determines how much value it can receive for the user's stored value, it generates an offer comprising an alternative form of value and sends the offer to intermediary 1300 via network communication interface 1310. For example, the offer to the user might comprise a re-loadable, pre-paid debit card worth an amount less than, equal to, or greater than, the value of the user's stored value. For instance, using the $60 pre-paid telephone card example cited above, the offer might comprise a $60 re-loadable, pre-paid debit card.

The offer from the first value provider is received by network communication interface 1310 and provided to processor 1306. In turn, processor 1306 generates an offer that is transmitted to the user via network communication interface 1310. The offer from intermediary 1300 is presented to the user in the form of a visual, audible, or both, message via apparatus 100. At that point, the user may grant acceptance of the offer by entering an indication of acceptance to apparatus 100 via a user input device. The indication of acceptance is transmitted to network communication interface 1310, where it is provided to processor 1306. Processor 1306 then generates a similar acceptance notification that is sent via network communication interface 1310 to the first value provider. The user's stored value is then provided to first value provider (either directly or through intermediary 1300), either electronically, or physically providing the stored value to the first value provider. In exchange, the user receives an alternative form of value from the first value provider (either directly or through intermediary 1300) as specified in the offer. In one embodiment, the user may instruct the first value provider on how to provide the alternative value to the user. Examples of this include printing a voucher, mailing a physical form of value to the user, such as a gift card, debit card, merchandise, etc., sending an electronic form of value to an account held by the user, such as the user's bank account, credit card account, debit card account, utility account, merchant account, social networking account, an e-commerce web site such as PayPal, or a combination of them. The electronic value could, in addition or alternatively, be sent via email, electronic message, or in an electronic format usable by an application running on a desktop or mobile computer, wireless telephone, personal mobile device such as a smart phone or iPad, or any other general or specialized electronic device. This electronic form of value may, alternatively or in addition, be sent to an account, email address or electronic device not associated directly with the user, such as a friend, relative, charity, merchant, utility company, financial institution, etc.

After the first value provider receives the user's stored value, it then sells or exchanges the stored value to a third party identified earlier in the process to recoup as much value as possible.

In one embodiment, at least a portion of the alternative value from the first value provider is conditional. That is, at least a portion of the value provided by the first value provider is only valid upon the occurrence of a future event. For example, the future event might comprise using the value before a certain future date, re-loading a debit card a minimum number of times, loading a debit card with a value greater than a pre-determined value, visiting a merchant location or website at least a predetermined number of times, a combination of some or all of the foregoing, etc.

In yet another embodiment, one form of conditional value may comprise value provided to the user if the user agrees to watch, or listen to, an advertisement provided by a value provider. The advertisement could comprise a visual image, video clip, audio clip, physical or electronic voucher, etc. In this case, once the user has indicated that he or she has reviewed the advertisement, the conditional value to the user can be unlocked or otherwise accessed or used.

It should be understood that in all of the embodiments discussed above, at the initiation stage of any exchange, the user could be presented with one or more exchange options to choose from, each exchange option allowing the user to exchange the user's stored value for another form(s) of value. This is opposed to the embodiments discussed above, where offer(s) are presented to the user after requests to value providers have been sent out. In this embodiment, for example, if the user enters stored value account information indicating that the stored value comprises a fuel card worth $100, a first exchange option might comprise exchanging the fuel card for a $100 debit card, a second exchange option might comprise exchanging the $100 fuel card for $110 for use on a social network web site, a third exchange option might comprise an $80 voucher for cash plus a $20 debit card, and a fourth exchange option might comprise exchanging the $100 fuel card for $95 in a voucher, redeemable at a location where apparatus 100 is situated. Of course, there could be a greater, or fewer, number of exchange options in other embodiments, and the type of value offered to the user in each exchange option could likewise comprise any form of value, or combinations of value. In any case, the user selects one of the exchange options and the transaction continues.

When offer(s) are received by apparatus 100, they may be combined to provide the user with the form(s) of value that the user requested, i.e., a combined value. This may be accomplished by a processor residing within apparatus 100, an intermediary, or a value provider. For example, if the user selected a $100 debit card for his or her $100 fuel card, and a first offer was received from a first value provider for a value of $90 and a second offer was received from a second value provider for $10, the values of the two offers could be combined, and either a voucher or a debit card could be dispensed from apparatus 100 with a total value of $100. In another embodiment, the two (or more) offers could be provided separately to the user via apparatus 100. At least some of the value could be conditional, as described above. In another embodiment, if the total value offered from the various value providers exceeds the value desired by the user, the excess may be provided to an owner of apparatus 100 or to some other entity for enabling the exchange.

It should be understood that in all of the embodiments discussed above, at the initiation stage of any exchange, the user could be presented with one or more exchange options to choose from, each exchange option allowing the user to exchange the user's stored value for another form(s) of value. This is opposed to the embodiments discussed above, where offer(s) are presented to the user after requests to value providers have been sent out. In this embodiment, for example, if the user enters stored value account information indicating that the stored value comprises a fuel card worth $100, a first exchange option might comprise exchanging the fuel card for a $100 debit card, a second exchange option might comprise exchanging the $100 fuel card for $110 for use on a social network web site, a third exchange option might comprise an $80 voucher for cash plus a $20 debit card, and a fourth exchange option might comprise exchanging the $100 fuel card for $95 in a voucher, redeemable at a location where apparatus 100 is situated. Of course, there could be a greater, or fewer, number of exchange options in other embodiments, and the type of value offered to the user in each exchange option could likewise comprise any form of value, or combinations of value. In any case, the user selects one of the exchange options and the transaction continues.

When offer(s) are received by apparatus 100, they may be combined to provide the user with the form(s) of value that the user requested. For example, if the user selected a $100 debit card for his or her $100 fuel card, and a first offer was received from a first value provider for a value of $90 and a second offer was received from a second value provider for $10, the values of the two offers could be combined, and either a voucher or a debit card could be dispensed from apparatus 100 with a total value of $100. In another embodiment, the two (or more) offers could be provided separately to the user via apparatus 100. At least some of the value could be conditional, as described above. In another embodiment, if the total value offered from the various value providers exceeds the value desired by the user, the excess may be provided to an owner of apparatus 100 or to some other entity for enabling the exchange.

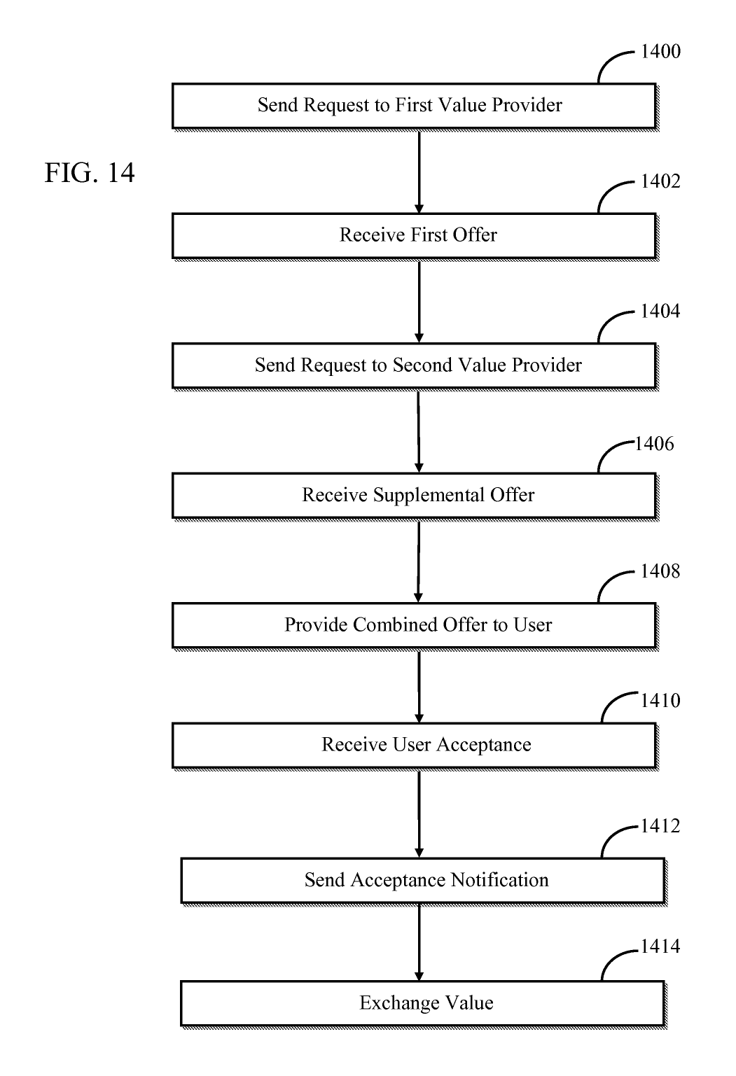

FIG. 14 is a flow diagram illustrating an embodiment of a process, performed by an apparatus, for example apparatus 100 shown in FIG. 1, for exchanging one form of stored value for an alternative form(s) of value. It should be understood that the steps presented in FIG. 14 is merely representative of one embodiment, and that a fewer, or greater, number of steps may be performed in alternative embodiments.

The process begins in step 1400, where a request is sent to a first value provider to provide an offer for a user's stored value. The request comprises stored value account information relating to the user's stored value. The first value provider receives the request, evaluates the stored value account information, and sends a first offer to the user to exchange the user's stored value for alternative value. The first offer is received by the user in step 1402. In step 1404, a second request is sent to a second value provider, requesting that second value provider offer additional value to the user in addition to the value offered by the first value provider. The second request generally comprises information relating to the user's stored value and the offer received from the first value provider. The second value provider sends a supplemental offer to the user, which is received in step 1406. Both offers are then presented to the user to be accepted or rejected together in step 1408. If the user accepts the two offers, shown in step 1410, a notification is sent to the first and second value providers in step 1412, alerting them that the user accepted their offers. The user's stored value is then credited to the first value provider, and the first value provider and the second value provider each provide the user with alternative forms of value, as presented in their respective offers, in step 1414.

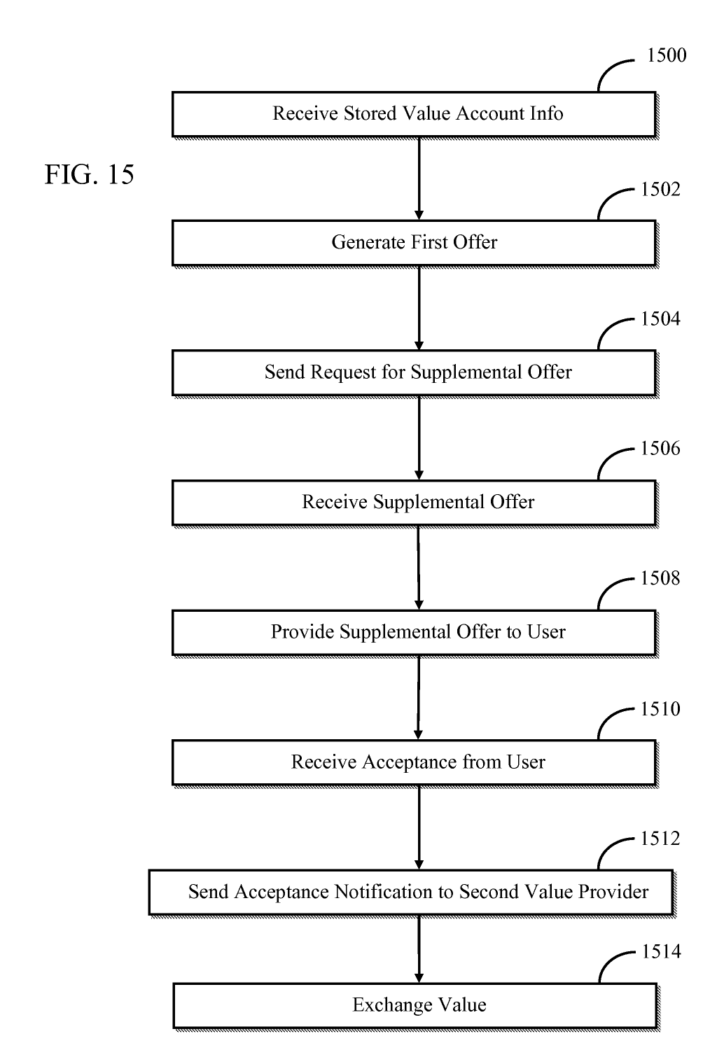

FIG. 15 is a flow diagram illustrating an embodiment of a process, performed by an entity, for example first value provider 300 shown in FIG. 3, for exchanging one form of stored value for an alternative form(s) of value. It should be understood that the steps presented in FIG. 15 are merely representative of one embodiment, and that a fewer, or greater, number of steps may be performed in alternative embodiments.

The process begins in step 1500, where stored value account information is received by the first value provider from a user desired to exchange the user's stored value for an alternate form(s) of value. The first value provider, in response to receiving the stored value account information, generates a first offer for the user comprising an alternative form of value and an amount of the alternative form of value, shown in step 1502. For example, the first value provider may receive stored value account information indicating that an individual desires to exchange a $100 Sears gift card for a Target gift card plus an additional form of value. First value provider happens to own, or can acquire, a Target gift card worth $90. The first offer, then, comprises the $90 Target gift card.

In step 1504, the first value provider sends a request for a supplemental offer to a second value provider, asking the second value provider to supplement the first offer. The second value provider may provide a supplemental offer based on information contained within the request, such as the nature and value of the user's stored value, the value of the first offer, etc. The supplemental offer is then provided to the first value provider where it is then received in step 1506. In step 1508, a combined offer is then sent to the user to review. If the user accepts the combined offer, a notification is received in step 1510 and a similar notification is sent to the second value provider in step 1512. The user's stored value is then credited to the first value provider, and the first value provider and second value provider each provide the user with alternative forms of value, as presented in their respective offers, shown in step 1514.

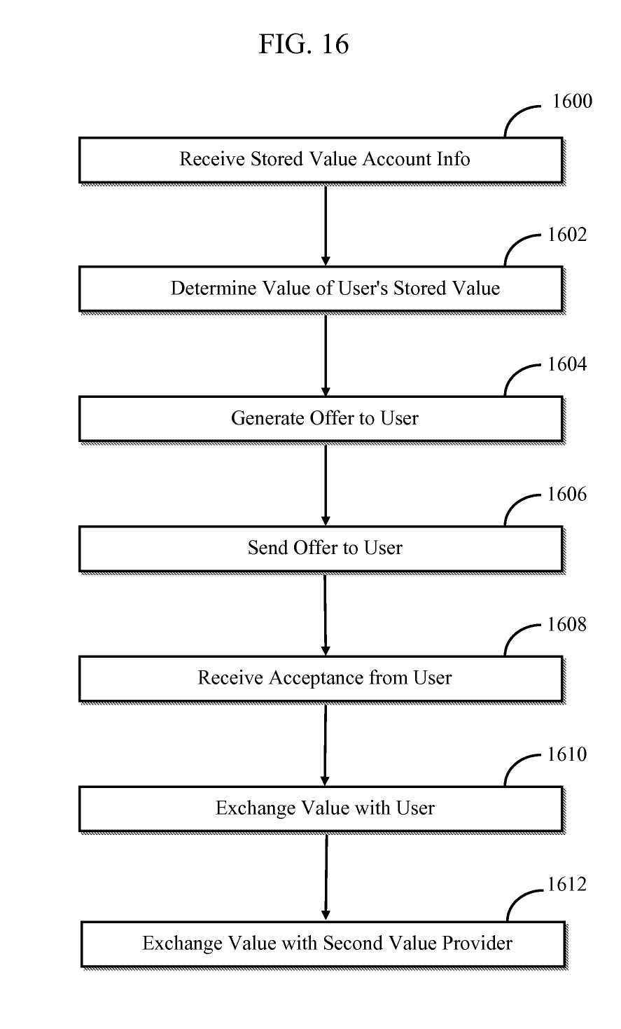

FIG. 16 is a flow diagram illustrating an embodiment of a process, performed by an entity, for example first value provider 400 shown in FIG. 4, for exchanging one form of stored value for an alternative form(s) of value. It should be understood that the steps presented in FIG. 16 are merely representative of one embodiment, and that a fewer, or greater, number of steps may be performed in alternative embodiments.

The process begins in step 1600, where stored value account information is received by the first value provider from a user wishing to exchange his or her stored value for an alternative form(s) of value. Next, in step 1602, the first value provider determines how much value it can receive by selling or exchanging the user's stored value to a third party, such as a second value provider. Next, in step 1604, an offer is generated and sent by the first value provider, offering to exchange the user's stored value for an alternative form of value, typically valued at least as much as the user's stored value. If the user accepts the offer, a notification is sent from the user to the first value provider in step 1606. The user's stored value is then credited to the first value provider, and the first value provider provides the user with the offered alternative value, shown in step 1608. Finally, in step 1610, the first value provider sells or exchanges the received stored value from the user to the second value provider identified in step 1602.

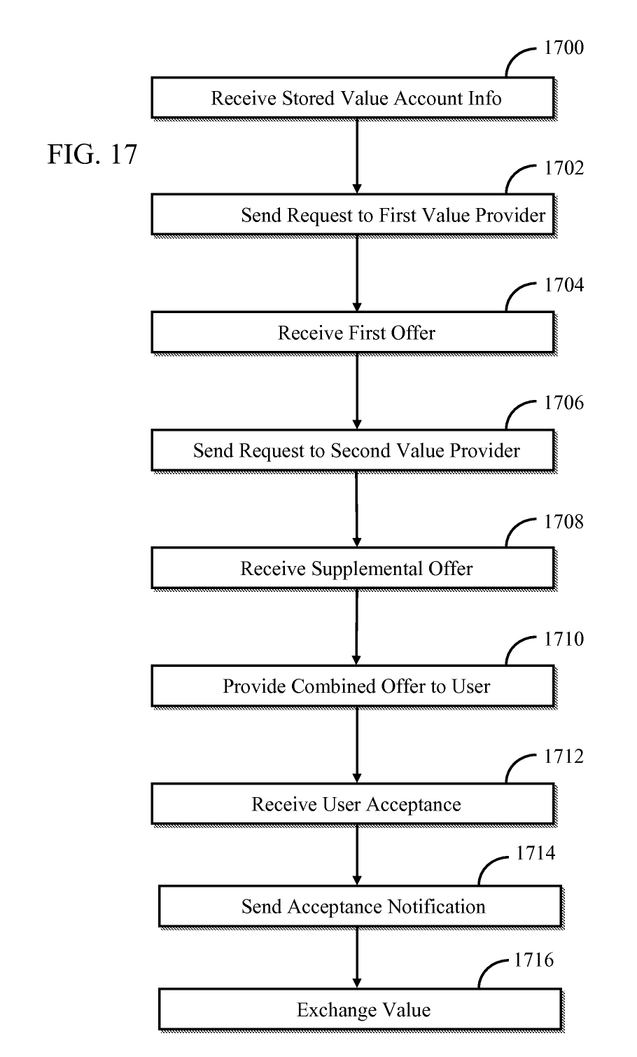

FIG. 17 is a flow diagram illustrating an embodiment of a process, performed by an entity, for example intermediary 500 shown in FIG. 5, for exchanging one form of stored value for an alternative form(s) of value. It should be understood that the steps presented in FIG. 17 are merely representative of one embodiment, and that a fewer, or greater, number of steps may be performed in alternative embodiments.

The process beings in step 1700, where stored value account information is received by the intermediary from a user wishing to exchange his or her stored value for an alternative form(s) of value. The intermediary, in response, sends a request to a first value provider to provide an offer to the intermediary for the user's stored value, shown in step 1702. In step 1704, a first offer is received from the first value provider by the intermediary, in the form of an offer for alternative value. In step 1706, a request is sent to a second value provider, requesting that second value provider offer additional value to the user in addition to the value offered by the first value provider. This request generally comprises information relating to the user's stored value and the offer received from the first value provider. The second value provider sends a supplemental offer to the user, which is received in step 1708. Both offers are then provided to the user to be accepted or rejected together in step 1710. If the user accepts the two offers, a notification is sent to the intermediary and received in step 1712. In step 1714, the intermediary sends a similar acceptance notification to the first and second value providers, alerting them that the user accepted their offers. The user's stored value is then credited to the first value provider, and the first value provider and the second value provider each provide the user with alternative forms of value, as presented in their respective offers, in step 1716, either directly or through the intermediary.

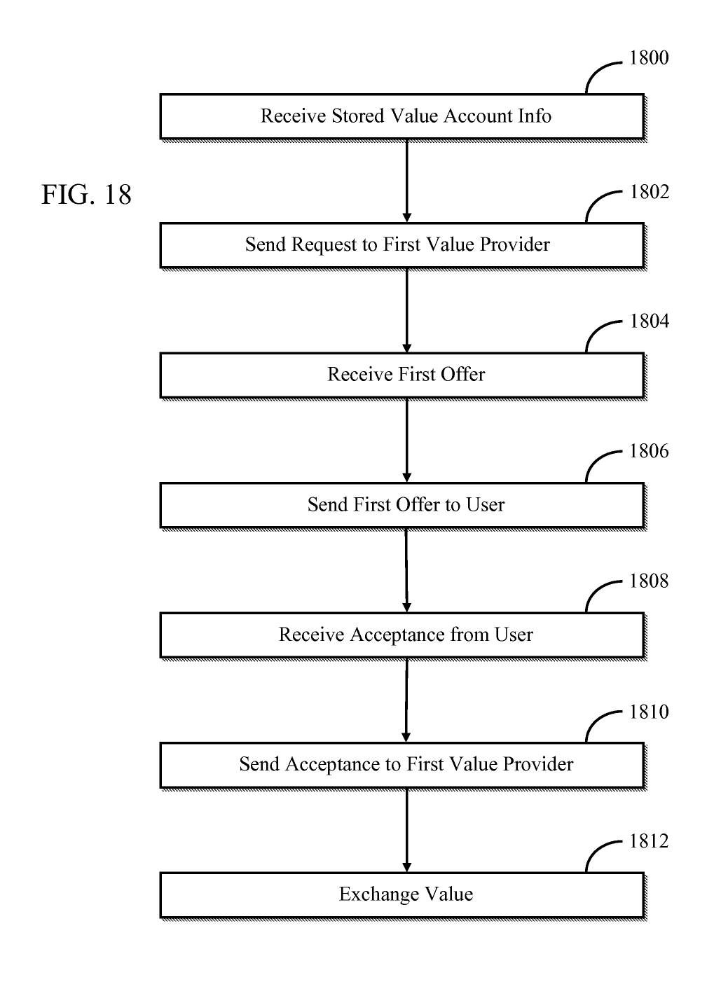

FIG. 18 is a flow diagram illustrating an embodiment of a process, performed by an entity, for example intermediary 600 shown in FIG. 6, for exchanging one form of stored value for an alternative form(s) of value. It should be understood that the steps presented in FIG. 18 are merely representative of one embodiment, and that a fewer, or greater, number of steps may be performed in alternative embodiments.

The process begins in step 1800, where stored value account information is received by the intermediary from a user desired to exchange the user's stored value for an alternate form(s) of value. The intermediary, in response to receiving the stored value account information, generates a first request to a first value provider to provide an offer for the user's stored value, shown in step 1802. In step 1804, a combined offer is received from the first value provider. The combined offer comprises an offer from the first value provider a supplemental offer from at least a second value provider. The supplemental offer is obtained by the first value provider by sending a request for a supplemental offer to the second value provider, asking the second value provider to supplement the first offer. The second value provider may provide a supplemental offer based on information contained within the request, such as the nature and value of the user's stored value, the value of the first offer, etc. The supplemental offer is then provided to the first value provider, and then the first value provider combines the two offers to form the combined offer.

In step 1806, the combined offer is sent from the intermediary to the user. If the user accepts the combined offer, a notification is received by the intermediary in step 1808 and a similar notification is sent to the first value provider in step 1810. The user's stored value is then credited to the first value provider, and the first value provider and second value provider each provide the user with alternative forms of value, as presented in their respective offers, shown in step 1812, either directly or through the intermediary.

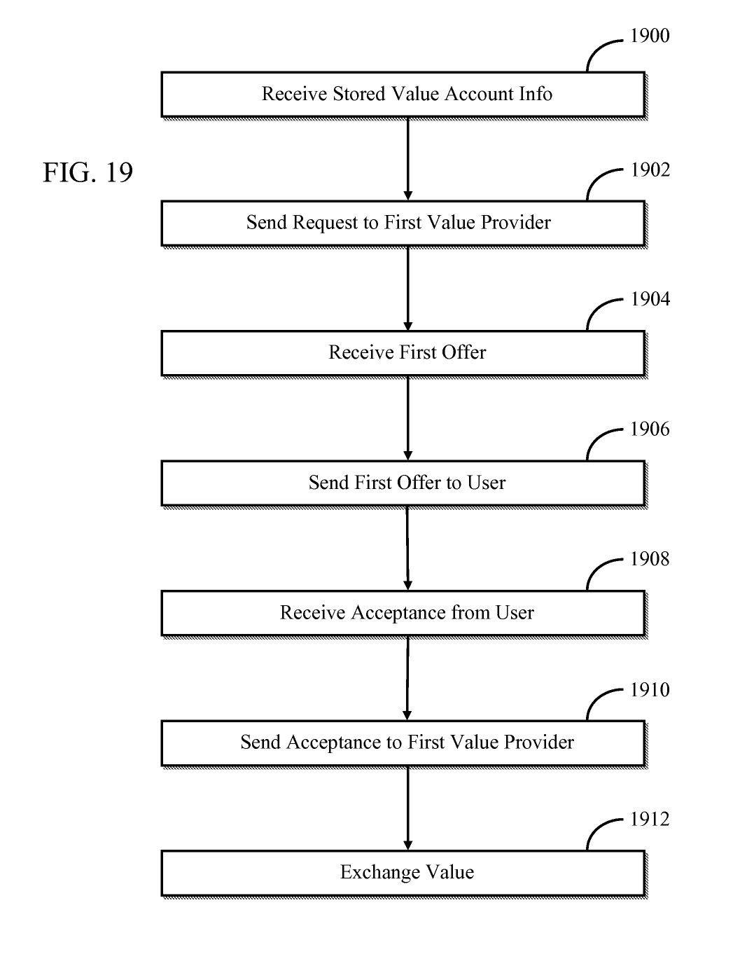

FIG. 19 is a flow diagram illustrating an embodiment of a process, performed by an entity, for example intermediary 700 shown in FIG. 7, for exchanging one form of stored value for an alternative form(s) of value. It should be understood that the steps presented in FIG. 19 are merely representative of one embodiment, and that a fewer, or greater, number of steps may be performed in alternative embodiments.

The process begins in step 1900, where stored value account information is received by the intermediary. In step 1902, the intermediary sends a request to a first value provider to provide an offer for the user's stored value. The request comprises the stored value account information as well. The first value provider determines how much value it can receive by selling or exchanging the user's stored value to a third party, such as a second value provider, as described above. The first value provider then generates an offer for the user's stored value and sends it to the intermediary in step 1904. In step 1906, the intermediary sends the offer to the user for acceptance. In step 1908, a notification is received from the user, indicating acceptance of the offer. The intermediary then forwards the acceptance notification to the first value provider in step 1910. Finally, in step 1912, the user's stored value is then credited to the first value provider (either directly or through intermediary 700), the first value provider provides the user with the offered alternative value (either directly or through intermediary 700), and the first value provider then sells the received stored value from the user to a third party, such as the second value provider.

The methods or algorithms described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components.

Accordingly, an embodiment of the invention can include a computer readable media embodying a code or processor-readable instructions to implement the methods of operation of the kiosk in accordance with the methods, algorithms, steps and/or functions disclosed herein.

While the foregoing disclosure shows illustrative embodiments of the invention, it should be noted that various changes and modifications could be made herein without departing from the scope of the invention as defined by the appended claims. The functions, steps and/or actions of the method claims in accordance with the embodiments of the invention described herein need not be performed in any particular order. Furthermore, although elements of the invention may be described or claimed in the singular, the plural is contemplated unless limitation to the singular is explicitly stated.

We claim:

1. A method for exchanging stored value for an alternative form of value, comprising:
receiving stored value account information relating to the stored value from a remote user device;
sending a request to a first value provider to provide an offer to exchange the store value for the alternative form of value;
receiving the offer, the offer comprising a first offer to exchange the stored value for an alternative form of value and a supplemental offer comprising a supplemental value; and
sending the first offer and the supplemental offer to the remote user device for acceptance.

2. The method of claim 1, wherein the request comprises at least some of the stored value account information.

3. The method of claim 1, wherein the first offer and the second offer is combined and sent to the remote user device as a combined offer.

4. The method of claim 1, wherein the alternative form of value and the supplemental value add up to a total value equal to or greater than the value of the stored value.

5. The method of claim 1, wherein the stored value account information comprises an identification of a merchant associated with the stored value and a monetary value.

6. The method of claim 1, further comprising exchanging the stored value for the first value and the supplemental value.

7. The method of claim 6, wherein the second value provider receives no value from the stored value.

8. The method of claim 1, wherein at least one of the values is conditional on the occurrence of a future event.

9. An apparatus for exchanging stored value for an alternative form of value, comprising:
a network communication interface for receiving stored value account information relating to the stored value from a remote user device, for sending a request to a first value provider to provide an offer to exchange the store value for the alternative form of value, for receiving the offer, the offer comprising a first offer to exchange the stored value for an alternative form of value and a supplemental offer comprising a supplemental value, and for sending the first offer and the supplemental offer to the remote user device for acceptance; and
a processor for generating the request.

10. The apparatus of claim 9, wherein the request comprises at least some of the stored value account information.

11. The apparatus of claim 9, wherein the processor is further for combining the first offer and the second offer to form a combined offer, and the network communication interface is further for sending the combined offer to the remote user device instead of the first offer and the supplemental offer.

12. The apparatus of claim 9, wherein the alternative form of value and the supplemental value add up to a total value equal to or greater than the value of the stored value.

13. The apparatus of claim 9, further comprising exchanging the stored value for the first value and the supplemental value.

14. The apparatus of claim 13, wherein the second value provider receives no value from the stored value.

15. The apparatus of claim 9, wherein at least one of the values is conditional on the occurrence of a future event.

16. An apparatus for exchanging stored value for an alternative form of value, comprising:
means for receiving stored value account information relating to the stored value from a remote user device, for sending a request to a first value provider to provide an offer to exchange the store value for the alternative form of value, for receiving the offer, the offer comprising a first offer to exchange the stored value for an alternative form of value and a supplemental offer comprising a supplemental value, and for sending the first offer and the supplemental offer to the remote user device for acceptance; and
means for generating the request.

17. The apparatus of claim 16, wherein at least one of the values is conditional on the occurrence of a future event.

18. The apparatus of claim 16, wherein the second value provider receives no value in exchange for the supplemental value.

19. The apparatus of claim 16, wherein the alternative form of value and the supplemental value add up to a total value equal to or greater than the value of the stored value.

20. The apparatus of claim 16, wherein the means for generating the request is further for combining the first offer and the second offer to form a combined offer, and the means for sending and receiving is further for sending the combined offer to the remote user device instead of the first offer and the supplemental offer.
